(19) United States
(12) Patent Application Publication
(10) Pub. No.: US 2020/0362113 A1
(43) Pub. Date: Nov. 19, 2020

(54) RESIN COMPOSITION

(71) Applicant: TORAY INDUSTRIES, INC., Tokyo (JP)

(72) Inventors: Yohei KIUCHI, Otsu-shi (JP); Ryoji OKUDA, Otsu-shi (JP)

(73) Assignee: TORAY INDUSTRIES, INC., Tokyo (JP)

(21) Appl. No.: 16/488,038

(22) PCT Filed: Mar. 15, 2018
(86) PCT No.: PCT/JP2018/010245

§ 371 Date: Aug. 22, 2019

(30) Foreign Application Priority Data
Mar. 22, 2017 (JP) 2017-055611

(51) Int. Cl. C08G 73/10; H01F 27/32

(52) U.S. Cl. CPC C08G 73/1082; H01F 27/323

(57) ABSTRACT

The purpose of the present invention is to provide a resin composition which enables the achievement of a cured film that has a low dielectric loss tangent and is capable of withstanding a heat treatment and a chemical treatment, said treatments being associated with the formation of a coil pattern. In order to achieve the above-described purpose, the configuration of the present invention is as follows. A resin composition which contains (P) a resin that has an alicyclic structure and an aromatic ring structure, and wherein the resin (P) that has an alicyclic structure and an aromatic ring structure has a group having two or more alicyclic rings and a group wherein two or more benzene rings are bonded by means of a single bond.

### TECHNICAL FIELD

The present invention relates to a resin composition, a resin sheet, and a cured film, and also to an electronic component, a semiconductor component, and a metal wire including the cured film.

### BACKGROUND ART

Resins typified by polyimides and polybenzoxazoles are used in passivation films of semiconductor devices and the like, interlayer insulating films of thin film inductors, insulating films of wire-winding inductors, insulating layers of organic EL elements, planarizing films of TFT substrates and the like based on their excellent mechanical properties, heat resistance, electrical insulation properties, chemical resistance, and the like.

In recent years, electronic components called high frequency inductors have attracted attention. High frequency inductors are used in a high frequency region from several tens of MHz to several GHz, and are mainly used in high frequency circuits and the like required for wireless communication functions of mobile communication devices such as smartphones and tablet terminals as well as wearable devices.

High frequency inductors can be classified according to the production method into three types of wire-winding inductors, multilayer inductors, and thin film inductors. In the wire-winding inductors, a coil is formed by winding, on a magnetic core or a nonmagnetic core, a metal wire having a coating of an insulating film. In the multilayer inductors, a coil is formed by forming a coil pattern via printing on a magnetic sheet or a nonmagnetic sheet, and stacking the sheets. In the thin film inductors, a volute thin film coil structure is formed on a substrate by repeating processes such as photolithography and plating.

Among these types of inductors, thin film inductors capable of space saving are needed, because an increase in the number and miniaturization of components in the substrate are required along with the recent sophistication and multifunctionality of mobile communication devices, in particular, smartphones.

Conventionally, a semi-additive process is employed to form a coil pattern of such thin film inductors. In the coil pattern formation by the semi-additive process, a coil pattern is formed through photolithography and a plating process, and then an interlayer insulating film is formed using a polyimide-based heat-resistant resin composition. When a multilayer coil structure is to be formed, the above-mentioned processes are repeated.

High frequency inductors, however, have the following problems.

In a high frequency region, a high dielectric loss occurs at an interface between the coil conductor and the interlayer insulating film to increase the transmission loss, so that a reduction in signal transmission efficiency and an operation failure occur. Therefore, an insulating material capable of suppressing an increase in dielectric loss in a high frequency region is desired. More specifically, desired is a resin composition capable of forming an insulating material that has a low dissipation factor and that can withstand heat treatment and chemical treatment associated with coil pattern formation.

Examples of a low-dielectric resin composition include: a polyimide precursor obtained by reacting an aromatic tetracarboxylic dianhydride with an alicyclic diamine such as 1,4-cyclohexyldiamine, and a method for producing the same (Patent Document 1); a polyimide obtained by reacting an aromatic tetracarboxylic acid such as pyromellitic dianhydride, an alicyclic diamine such as 1,4-cyclohexyldiamine, and an aromatic diamine such as 2,2′-bis(trifluoromethyl)benzidine, and a precursor thereof (Patent Document 2); a polyimide resin composition obtained by adding, to a solvent-soluble polyimide obtained by reacting an alicyclic tetracarboxylic dianhydride with an alicyclic diamine such as 4,4′-diaminodicyclohexylmethane, an epoxy compound having two or more epoxy groups in one molecule (Patent Document 3); and a polyimide resin composition obtained by dissolving an aromatic tetracarboxylic dianhydride and an alicyclic diamine such as 1,4-cyclohexyldiamine in a specific organic solvent (Patent Document 4).

### PRIOR ART DOCUMENTS

### Patent Documents

Patent Document 1: Japanese Patent Laid-open Publication No. 2002-161136

Patent Document 2: Japanese Patent Laid-open Publication No. 2002-327056

Patent Document 3: Japanese Patent Laid-open Publication No. 2008-163210

Patent Document 4: Japanese Patent Laid-open Publication No. 2012-188614

### SUMMARY OF THE INVENTION

### Problems to be Solved by the Invention

All of the resin compositions described in Patent Documents 1 to 4, however, have a problem that the resin compositions have an inadequate dissipation factor in a high frequency region, and have room for improvement.

Then, an object of the present invention is to provide a resin composition capable of providing a cured film that has a low dissipation factor and that can withstand heat treatment and chemical treatment associated with coil pattern formation.

### Solutions to the Problems

As a result of investigations to solve the above-mentioned problems, the present inventors obtained the following findings (I) to (III).

(I) Introducing a bulky structure having a plurality of alicyclic rings into a main chain terminal of a resin tended to lower the dissipation factor. This is presumably due to the effect of reducing the molar polarizability per molar volume of the resin and of reducing polar groups at the main chain terminal.

(II) Introducing an alicyclic structure into the resin at a specific rate tended to lower the dissipation factor. This is presumably because the molar polarizability per molar volume of the alicyclic structure is lower than that of an aromatic ring structure or the like.

(III) Since a correlation was observed between the dissipation factor in a high frequency region and the molecular mobility in a low temperature region, introducing a rigid structure into the resin to constrain free rotation and to suppress the molecular mobility in a low temperature region tended to lower the dissipation factor.

The resin composition of the present invention was completed as a result of the above-mentioned findings and repeated investigations, and has the following constitution. More specifically, the present invention has the following constitution.

[1] A resin composition containing (P) a resin having an alicyclic structure and an aromatic ring structure, wherein the resin (P) having an alicyclic structure and an aromatic ring structure has a group having two or more alicyclic rings, and also has a group in which two or more benzene rings are bonded via a single bond.
[2] The resin composition according to the item [1], wherein the group having two or more alicyclic rings in the resin (P) having an alicyclic structure and an aromatic ring structure is represented by at least one group selected from the group consisting of general formulae (1) and (2):

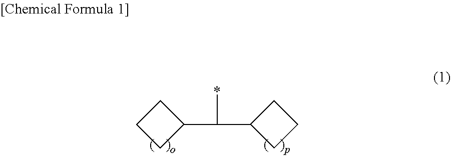

wherein o and p may be identical or different, and each represent an integer within a range of 1 to 10, and symbol * represents a bond; and

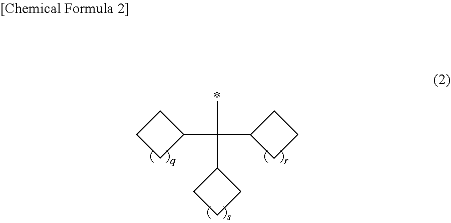

wherein q, r, and s may be identical or different, and each represent an integer within a range of 1 to 10, and symbol * represents a bond.

[3] The resin composition according to the item [1] or [2], wherein a main chain terminal of the resin (P) having an alicyclic structure and an aromatic ring structure has at least one group selected from the group consisting of general formulae (1) and (2):

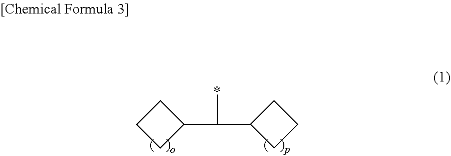

wherein o and p may be identical or different, and each represent an integer within a range of 1 to 10, and symbol * represents a bond; and

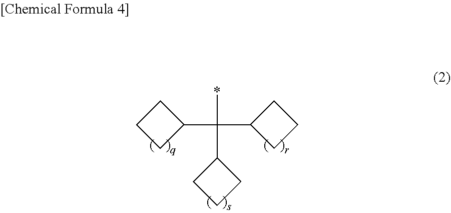

wherein q, r, and s may be identical or different, and each represent an integer within a range of 1 to 10, and symbol * represents a bond.

[4] The resin composition according to any one of the items [1] to [3], wherein the resin (P) having an alicyclic structure and an aromatic ring structure contains at least one resin selected from the group consisting of a polyamide, a polyimide, a polyamic acid, a polyamic acid ester, a polybenzoxazole, and a polyhydroxyamide.
[5] The resin composition according to any one of the items [1] to [4], wherein the resin (P) having an alicyclic structure and an aromatic ring structure has (a) a diamine residue and (b) a carboxylic acid residue,

the diamine residue (a) contains, to a total of 100 mol % of the diamine residue (a), (a-1) an alicyclic diamine residue at a content rate of 60 to 80 mol %, and (a-2) an aromatic diamine residue at a content rate of 20 to 40 mol %, and

the carboxylic acid residue (b) contains, to a total of 100 mol % of the carboxylic acid residue (b), (b-1) an aromatic tetracarboxylic acid residue at a content rate of 60 to 100 mol %.

[6] The resin composition according to the item [5], wherein the alicyclic diamine residue (a-1) has at least one structure selected from the group consisting of general formulae (3), (4), and (5):

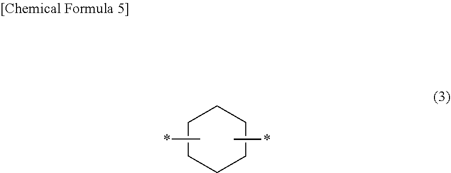

wherein symbol * represents a bond;

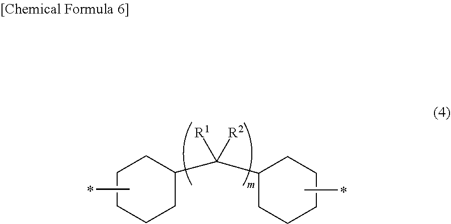

wherein R¹ and R² may be identical or different, and each represent a hydrogen atom, a methyl group, or a trifluoromethyl group, m represents an integer within a range of 1 to 10, and symbol * represents a bond; and

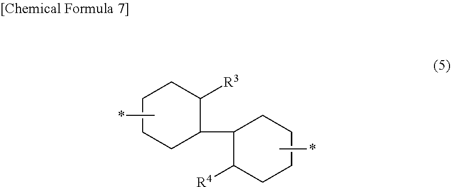

wherein R³ and R⁴ may be identical or different, and each represent a hydrogen atom, a methyl group, or a trifluoromethyl group, and symbol * represents a bond.

[7] The resin composition according to the item [5] or [6], wherein the aromatic tetracarboxylic acid residue (b-1) has at least one structure selected from the group consisting of a formula (6) and a general formula (7):

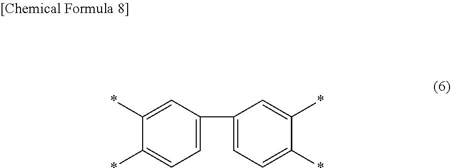

wherein symbol * represents a bond; and

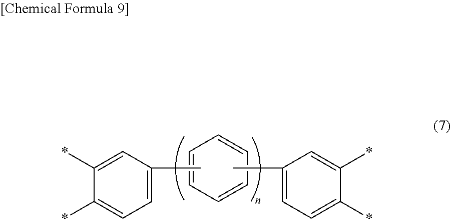

wherein n represents an integer within a range of 1 to 10, and symbol * represents a bond.

[8] The resin composition according to any one of the items [1] to [7], wherein the resin (P) having an alicyclic structure and an aromatic ring structure has an ester group-containing side chain, and

the resin (P) having an alicyclic structure and an aromatic ring structure contains, to a total of 100 mol % of side chains in the resin (P) having an alicyclic structure and an aromatic ring structure, the ester group-containing side chain at a rate of 60 to 95 mol %.

[9] The resin composition according to any one of the items [1] to [8], wherein the resin (P) having an alicyclic structure and an aromatic ring structure has a molecular weight within a range of 100 or more and 1,000,000 or less.
[10] The resin composition according to the item [9], wherein the resin (P) having an alicyclic structure and an aromatic ring structure contains, to 100 mass % in total of a component having the molecular weight within the range of 100 or more and 1,000,000 or less in the resin (P) having an alicyclic structure and an aromatic ring structure, a component having a molecular weight within a range of 5,000 or more and 1,000,000 or less at a content rate of 95 mass % or more and 100 mass % or less.
[11] A resin composition containing (P) a resin having an alicyclic structure and an aromatic ring structure,

wherein the resin (P) having an alicyclic structure and an aromatic ring structure has at least one structure selected from the group consisting of general formulae (8), (9), and (10), and also has a group in which two or more benzene rings are bonded via a single bond:

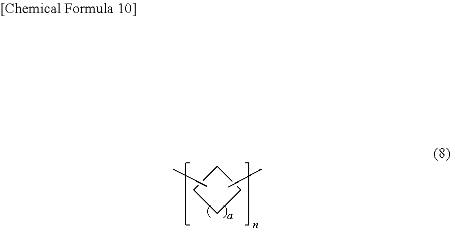

wherein a represents an integer within a range of 1 to 10, and n represents an integer within a range of 1 to 1000;

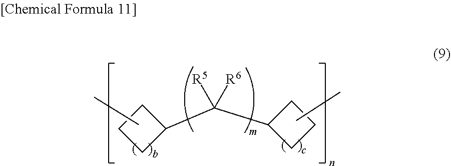

wherein R⁵ and R⁶ may be identical or different, and each represent a hydrogen atom, a methyl group, or a trifluoromethyl group, b and c may be identical or different, and each represent an integer within a range of 1 to 10, m represents an integer within a range of 1 to 10, and n represents an integer within a range of 1 to 1000; and

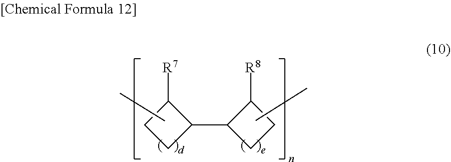

wherein R⁷ and R⁸ may be identical or different, and each represent a hydrogen atom, a methyl group, or a trifluoromethyl group, d and e may be identical or different, and each represent an integer within a range of 1 to 10, and n represents an integer within a range of 1 to 1000.

[12] A resin sheet containing the resin composition according to any one of the items [1] to [11].
[13] The resin sheet according to the item [12], having a film thickness of 3 to 50 μm.
[14] A cured film including a cured product of the resin composition according to any one of the items [1] to [11] or of the resin sheet according to the item [12] or [13].
[15] An electronic component or a semiconductor component including the cured film according to the item [14] arranged therein.
[16] An electronic component including a coil structure including two to ten repeatedly arranged layers of the cured films according to the item [14] as interlayer insulating films.
[17] A metal wire including the cured film according to the item [14] arranged therein.
[18] An electronic component including a coil structure including the metal wire according to the item [17].

### Effects of the Invention

The present invention can provide a resin composition capable of providing a cured film that has a low dissipation factor and that can withstand heat treatment and chemical treatment associated with coil pattern formation.

### BRIEF DESCRIPTION OF THE DRAWINGS

FIG. 1 is an enlarged cross-sectional view of a pad portion of a semiconductor component having interlayer insulating films.

FIG. 2 is an enlarged cross-sectional view of a multilayer structure portion of an electronic component, the multilayer structure portion including insulating layers and coil conductor layers that are alternately laminated.

### EMBODIMENTS OF THE INVENTION

A first aspect of the resin composition according to the present invention is a resin composition containing (P) a resin having an alicyclic structure and an aromatic ring structure, wherein the resin (P) having an alicyclic structure and an aromatic ring structure has a group having two or more alicyclic rings, and also has a group in which two or more benzene rings are bonded via a single bond.

The resin composition of the present invention preferably contains, as the resin (P) having an alicyclic structure and an aromatic ring structure, at least one resin selected from the group consisting of an acrylic resin, an epoxy resin, a phenol resin, a urea resin, a polyphenylene sulfide, a polyamide, a polyimide, a polyamic acid, a polyamic acid ester, a polybenzoxazole, a polyhydroxyamide, and a cycloolefin polymer. In particular, it is more preferable that the resin composition contain at least one resin selected from the group consisting of a polyamide, a polyimide, a polyamic acid, a polyamic acid ester, a polybenzoxazole, and a polyhydroxyamide. These resins can turn into a polymer having a cyclic structure such as an imide ring and an oxazole ring by heating or with a catalyst. Since the resin turns into a polymer having a cyclic structure, the resin tends to be remarkably improved in heat resistance and chemical resistance.

In the present invention, it is preferable that the resin (P) having an alicyclic structure and an aromatic ring structure have (a) a diamine residue, and that the diamine residue (a) contain (a-1) an alicyclic diamine residue and (a-2) an aromatic diamine residue. Herein, the “diamine residue” refers to an organic group resulting from removal of an amino group from a diamine.

In the present invention, it is preferable that the resin (P) having an alicyclic structure and an aromatic ring structure have (b) a carboxylic acid residue, and that the carboxylic acid residue (b) contain (b-1) an aromatic tetracarboxylic acid residue. Herein, the “carboxylic acid residue” refers to an organic group resulting from removal of a carboxyl group from a carboxylic acid.

For example, a polyimide has (a) a diamine residue and (b) a carboxylic acid residue, and can be obtained by reacting a tetracarboxylic acid, a corresponding tetracarboxylic dianhydride, a corresponding tetracarboxylic acid diester dichloride or the like with a diamine, a corresponding diisocyanate compound, or a corresponding trimethylsilylated diamine. For example, a polyimide can be obtained by subjecting a polyamic acid, which is one of polyimide precursors obtained by reacting a diamine with a tetracarboxylic dianhydride, to dehydration ring-closing through heat treatment. In the heat treatment, a solvent that forms an azeotrope with water, such as m-xylene, can also be added. Alternatively, a polyimide can also be obtained by subjecting a polyamic acid to dehydration ring-closing through chemical heat treatment by adding a dehydration condensation agent such as a carboxylic anhydride or dicyclohexylcarbodiimide, or a base such as triethylamine as a ring-closing catalyst. Still alternatively, a polyimide can also be obtained by subjecting a polyamic acid to dehydration ring-closing through heat treatment at a low temperature of 100° C. or lower by adding a weakly acidic carboxylic acid compound. The polyimide precursor will be described later.

A polybenzoxazole has (a) a diamine residue having a phenolic hydroxyl group and (b) a carboxylic acid residue, and can be obtained by reacting a bisaminophenol compound with a dicarboxylic acid, a corresponding dicarboxylic acid chloride, a corresponding dicarboxylic acid active ester or the like. For example, a polybenzoxazole can be obtained by subjecting a polyhydroxyamide, which is one of polybenzoxazole precursors obtained by reacting a bisaminophenol compound with a dicarboxylic acid, to dehydration ring-closing through heat treatment. Alternatively, a polybenzoxazole can also be obtained by subjecting a polyhydroxyamide to dehydration ring-closing through chemical treatment by adding anhydrous phosphoric acid, a base, a carbodiimide compound or the like. The polybenzoxazole precursor will be described later.

The polyimide precursor and the polybenzoxazole precursor are resins having an amide bond in the main chain, and are subjected to dehydration ring-closing through heat treatment or chemical treatment to turn into the above-mentioned polyimide or polybenzoxazole. The number of repeating structural units is preferably 10 to 100,000. Examples of the polyimide precursor include polyamic acids, polyamic acid esters, polyamic acid amides, and polyisoimides. Among them, polyamic acids and polyamic acid esters are preferable. Examples of the polybenzoxazole precursor include polyhydroxyamides, polyaminoamides, polyamides, and polyamideimides. Among them, polyhydroxyamides are preferable.

In the present invention, a preferable component of the diamine residue and a bisaminophenol residue (hereinafter collectively referred to as the “diamine residue (a)”) is a component having the alicyclic diamine residue (a-1) and the aromatic diamine residue (a-2).

In the resin composition of the present invention, it is preferable that the alicyclic diamine residue (a-1) have at least one structure selected from the group consisting of general formulae (3), (4), and (5):

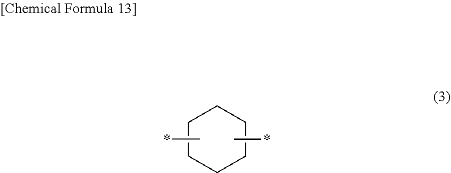

wherein symbol * represents a bond;

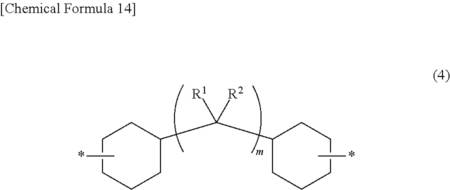

wherein R¹ and R² may be identical or different, and each represent a hydrogen atom, a methyl group, or a trifluoromethyl group, m represents an integer within a range of 1 to 10, and symbol * represents a bond; and

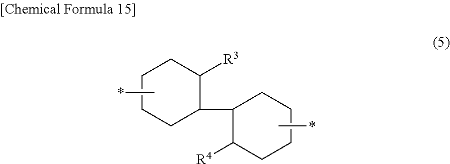

wherein R³ and R⁴ may be identical or different, and each represent a hydrogen atom, a methyl group, or a trifluoromethyl group, and symbol * represents a bond.

In particular, examples of a preferable structure of the alicyclic diamine residue (a-1) include structures shown below, and structures in which some hydrogen atoms, that is, 1 to 4 hydrogen atoms in these structures are substituted with an alkyl group having 1 to 20 carbon atoms, a fluoroalkyl group, an alkoxyl group, an ester group, a nitro group, a cyano group, a fluorine atom, or a chlorine atom.

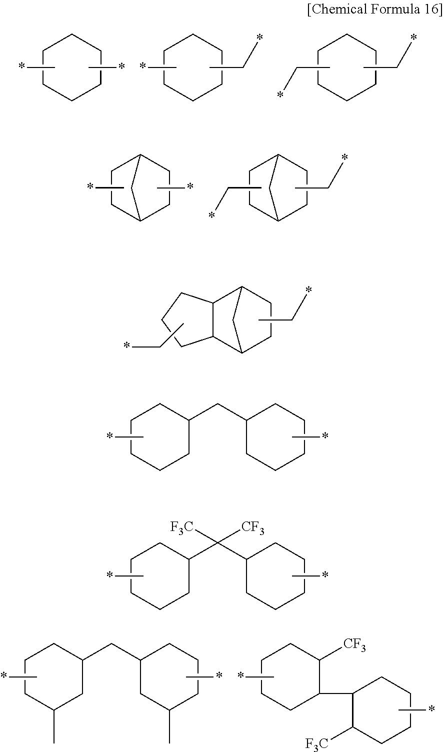

Symbol * represents a bond.

Moreover, examples of a preferable structure of the aromatic diamine residue (a-2) include structures shown below, and structures in which some hydrogen atoms, that is, 1 to 4 hydrogen atoms in these structures are substituted with an alkyl group having 1 to 20 carbon atoms, a fluoroalkyl group, an alkoxyl group, an ester group, a nitro group, a cyano group, a fluorine atom, or a chlorine atom.

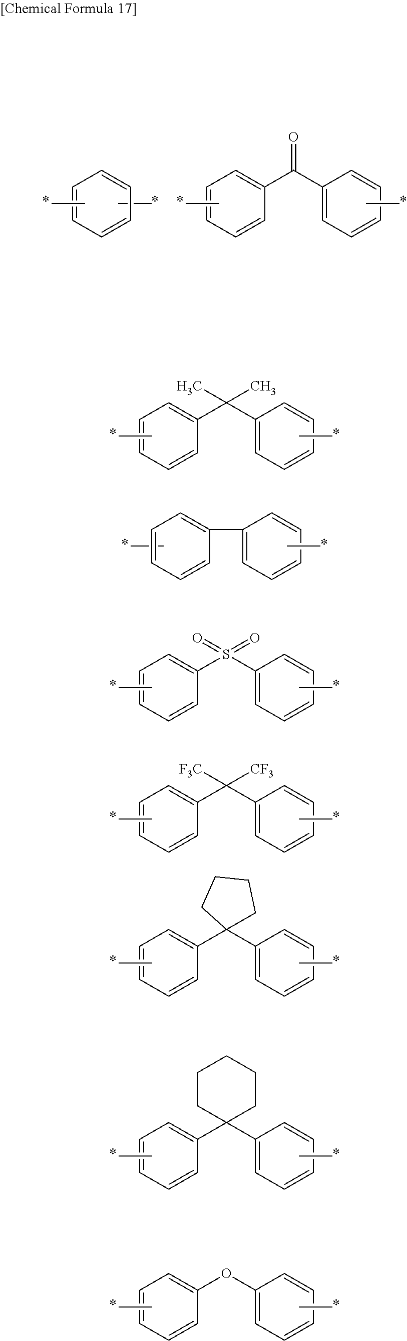

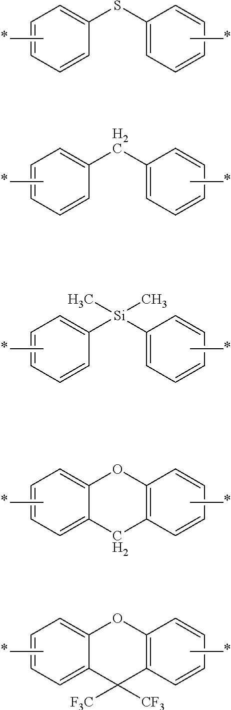

Symbol * represents a bond.

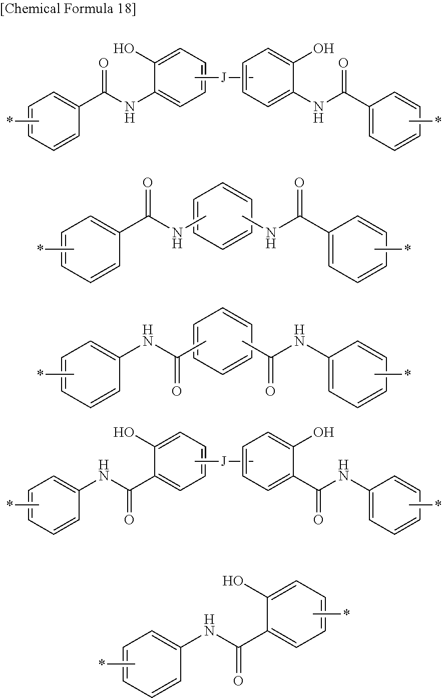

In the formulae, each symbol J represents any of a direct bond, —COO—, —CONH—, —CH₂—, —C₂H₄—, —O—, —C₃H₆—, —C₃F₆—, —SO₂—, —S—, —Si(CH₃)₂—, —O—Si(CH₃)₂—O—, —C₆H₄—, —C₆H₄—O—C₆H₄—, —C₆H₄—C₃H₆—C₆H₄—, and —C₆H₄—C₃F₆—C₆H₄—. Symbol * represents a bond.

In the present invention, a preferable component of a tetracarboxylic acid residue and a dicarboxylic acid residue (hereinafter collectively referred to as the “carboxylic acid residue (b)”) is a component having the aromatic tetracarboxylic acid residue (b-1).

The aromatic tetracarboxylic acid residue (b-1) preferably used in the present invention is a residue having at least one structure selected from the group consisting of a formula (6) and a general formula (7):

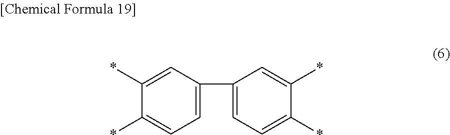

wherein symbol * represents a bond; and

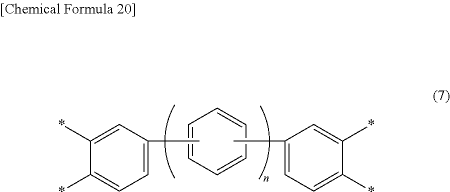

wherein n represents an integer within a range of 1 to 10, and symbol * represents a bond.

In particular, examples of a preferable structure of the aromatic tetracarboxylic acid residue (b-1) include structures shown below, and structures in which some hydrogen atoms, that is, 1 to 4 hydrogen atoms in these structures are substituted with an alkyl group having 1 to 20 carbon atoms, a fluoroalkyl group, an alkoxyl group, an ester group, a nitro group, a cyano group, a fluorine atom, or a chlorine atom.

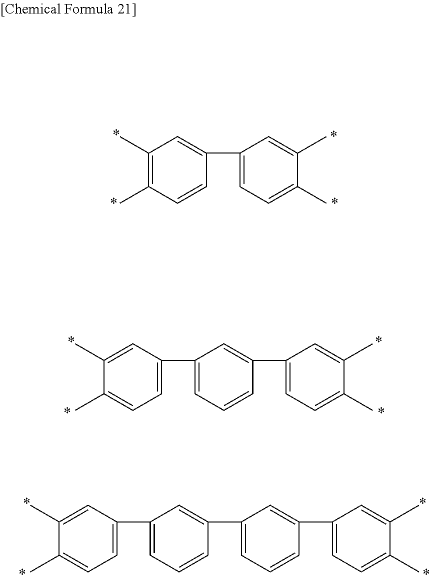

Symbol * represents a bond.

Further, as structures of the aromatic tetracarboxylic acid residue (b-1) other than the formula (6) and the general formula (7), it is also possible to use structures shown below, or structures in which some hydrogen atoms, that is, 1 to 4 hydrogen atoms in these structures are substituted with an alkyl group having 1 to 20 carbon atoms, a fluoroalkyl group, an alkoxyl group, an ester group, a nitro group, a cyano group, a fluorine atom, or a chlorine atom.

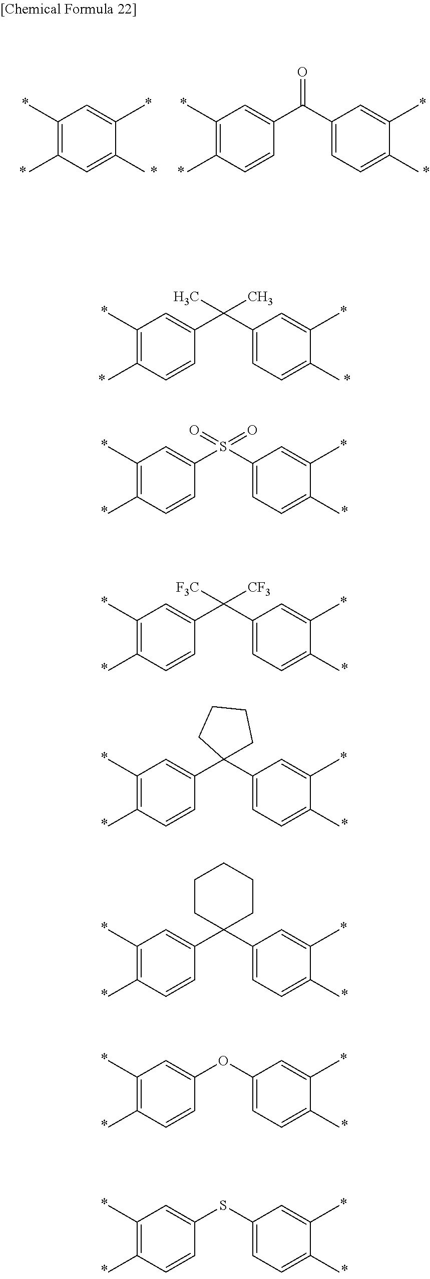

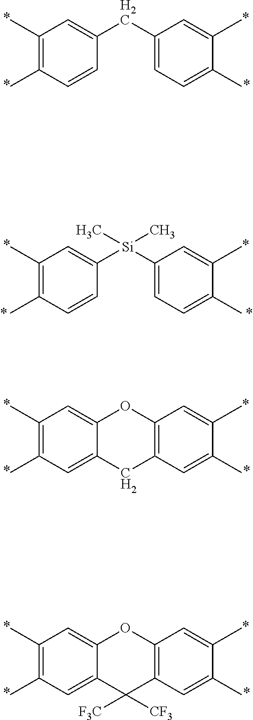

Symbol * represents a bond.

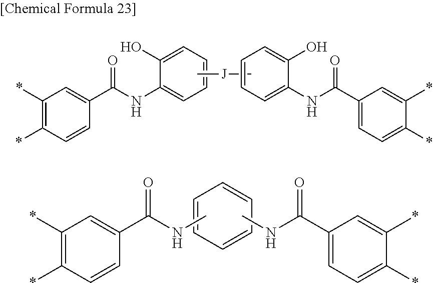

In the formulae, symbol J represents any of a direct bond, —COO—, —CONH—, —CH₂—, —C₂H₄—, —O—, —C₃H₆—, —C₃F₆—, —SO₂—, —S—, —Si(CH₃)₂—, —OSi(CH₃)₂—O—, —C₆H₄—, —C₆H₄—O—C₆H₄—, —C₆H₄—C₃H₆—C₆H₄—, and —C₆H₄—C₃F₆—C₆H₄—. Symbol * represents a bond.

Further, as structures of the carboxylic acid residue (b) other than the aromatic tetracarboxylic acid residue (b-1), it is also possible to use structures shown below, or structures in which some hydrogen atoms, that is, 1 to 4 hydrogen atoms in these structures are substituted with an alkyl group having 1 to 20 carbon atoms, a fluoroalkyl group, an alkoxyl group, an ester group, a nitro group, a cyano group, a fluorine atom, or a chlorine atom.

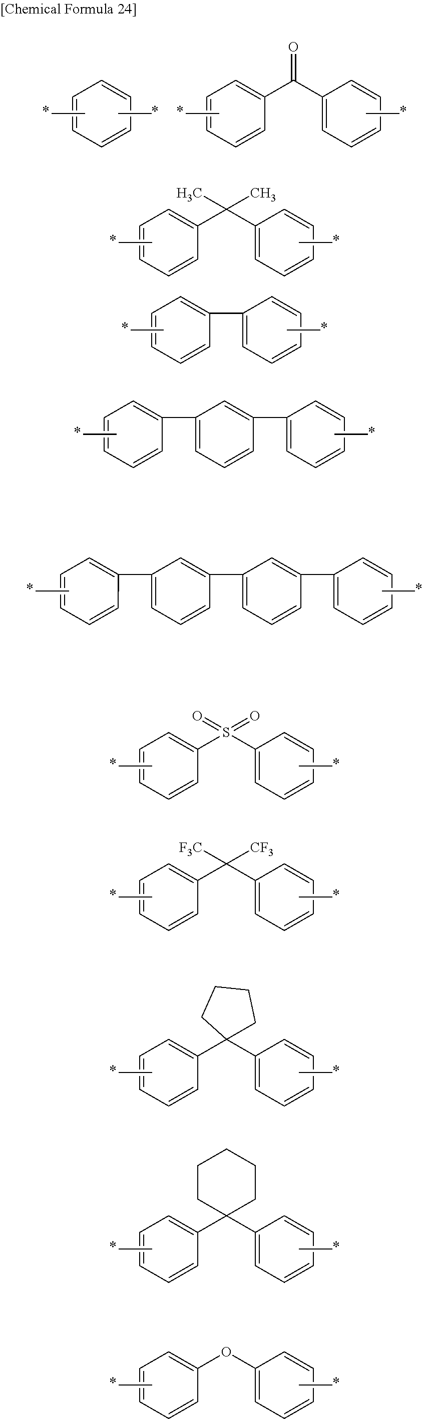

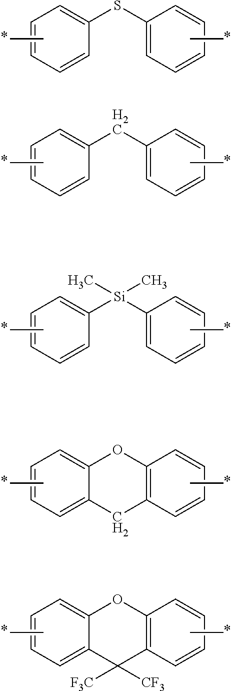

Symbol * represents a bond.

Examples of the diamine of the alicyclic diamine residue (a-1) that constitutes the diamine residue (a) include 4,4′-diaminodicyclohexylmethane, 3,3′-dimethyl-4,4′-diaminodicyclohexylmethane, 1,3-diaminocyclohexane, 1,4-diaminocyclohexane, isophoronediamine, 1,3-bisaminomethylcyclohexane, 1,4-bisaminomethylcyclohexane, bis(aminomethyl)norbornane, (4),8(9)-bis(aminomethyl)tricyclo[5.2.1.0^{2,6}]decane, 2,2′-bis(4-aminocyclohexyl)-hexafluoropropane, and 2,2′-bis(trifluoromethyl)-4,4′-diaminobicyclohexane.

Among the above-mentioned alicyclic diamines of the alicyclic diamine residue (a-1), 4,4′-diaminodicyclohexylmethane, 3,3′-dimethyl-4,4′-diaminodicyclohexylmethane, 1,3-diaminocyclohexane, 1,4-diaminocyclohexane, 2,2′-bis(4-aminocyclohexyl)-hexafluoropropane, and 2,2′-bis(trifluoromethyl)-4,4′-diaminobicyclohexane are preferable from the viewpoint of low dissipation factor and film toughness.

Moreover, examples of the aromatic diamine of the aromatic diamine residue (a-2) that constitutes the diamine residue (a) include: hydroxyl group-containing diamines such as 2,2-bis(3-amino-4-hydroxyphenyl)hexafluoropropane, bis(3-amino-4-hydroxyphenyl)sulfone, bis(3-amino-4-hydroxyphenyl)propane, bis(3-amino-4-hydroxyphenyl)methylene, bis(3-amino-4-hydroxyphenyl)ether, bis(3-amino-4-hydroxy)biphenyl, and bis(3-amino-4-hydroxyphenyl)fluorene; carboxyl group-containing diamines such as 3,5-diaminobenzoic acid and 3-carboxy-4,4′-diaminodiphenyl ether; sulfonic acid-containing diamines such as 3-sulfonic acid-4,4′-diaminodiphenyl ether; dithiohydroxyphenylenediamine, 3,4′-diaminodiphenyl ether, 4,4′-diaminodiphenyl ether, 3,4′-diaminodiphenylmethane, 4,4′-diaminodiphenylmethane, 3,4′-diaminodiphenyl sulfone, 4,4′-diaminodiphenyl sulfone, 3,4′-diaminodiphenyl sulfide, 4,4′-diaminodiphenyl sulfide, 1,4-bis(4-aminophenoxy)benzene, m-phenylenediamine, p-phenylenediamine, 1,5-naphthalenediamine, 2,6-naphthalenediamine, bis(4-aminophenoxyphenyl)sulfone, bis(3-aminophenoxyphenyl)sulfone, bis(4-aminophenoxy)biphenyl, bis{4-(4-aminophenoxy)phenyl}ether, 1,4-bis(4-aminophenoxy)benzene, 2,2′-dimethyl-4,4′-diaminobiphenyl, 2,2′-diethyl-4,4′-diaminobiphenyl, 3,3′-dimethyl-4,4′-diaminobiphenyl, 3,3′-diethyl-4,4′-diaminobiphenyl, 2,2′,3,3′-tetramethyl-4,4′-diaminobiphenyl, 3,3′,4,4′-tetramethyl-4,4′-diaminobiphenyl, 2,2′-bis(trifluoromethyl)-4,4′-diaminobiphenyl, and compounds obtained by substituting some of hydrogen atoms of aromatic rings of these compounds with an alkyl group or a halogen atom such as a F, Cl, Br, or I atom. Furthermore, in these diamines, some of hydrogen atoms may be substituted with an alkyl group having 1 to 10 carbon atoms, such as a methyl group and an ethyl group, a fluoroalkyl group having 1 to 10 carbon atoms, such as a trifluoromethyl group, or a halogen atom such as a F, Cl, Br, or I atom.

Among the above-mentioned aromatic diamines of the aromatic diamine residue (a-2), 3,4′-diaminodiphenyl ether and 4,4′-diaminodiphenyl ether are preferable from the viewpoint of low dissipation factor and film toughness.

These diamines can be used as they are, or as corresponding diisocyanate compounds or corresponding trimethylsilylated diamines. Moreover, two or more of these diamines may be used.

Examples of the diamine other than the alicyclic diamine of the alicyclic diamine residue (a-1) and the aromatic diamine of the aromatic diamine residue (a-2) include: aliphatic diamines such as ethylene diamine, 1,3-diaminopropane, 2-methyl-1,3-propanediamine, 1,4-diaminobutane, 1,5-diaminopentane, 2-methyl-1,5-diaminopentane, 1,6-diaminohexane, 1,7-diaminoheptane, 1,8-diaminooctane, 1,9-diaminononane, 1,10-diaminodecane, 1,11-diaminoundecane, and 1,12-diaminododecane; and silicon atom-containing diamines such as 1,3-bis(3-aminopropyl)tetramethyldisiloxane and 1,3-bis(4-anilino)tetramethyldisiloxane.

Examples of the component that constitutes the carboxylic acid residue (b) include: dicarboxylic acids such as terephthalic acid, isophthalic acid, diphenyl ether dicarboxylic acid, bis(carboxyphenyl)hexafluoropropanc, biphenyldicarboxylic acid, benzophenone dicarboxylic acid, and triphenyldicarboxylic acid; and tricarboxylic acids such as trimellitic acid, trimesic acid, diphenyl ether tricarboxylic acid, and biphenyltricarboxylic acid. Examples of the aromatic tetracarboxylic acid of the aromatic tetracarboxylic acid residue (b-1) include aromatic tetracarboxylic acids such as pyromellitic acid, 3,3′,4,4′-biphenyltetracarboxylic acid, 2,3,3′,4′-biphenyltetracarboxylic acid, 2,2′,3,3′-biphenyltetracarboxylic acid, 3,3′,4,4′-benzophenonetetracarboxylic acid, 2,2′,3,3′-benzophenonetetracarboxylic acid, 2,2-bis(3,4-dicarboxyphenyl)hexafluoropropane, 2,2-bis(2,3-dicarboxyphenyl)hexafluoropropane, 1,1-bis(3,4-dicarboxyphenyl)ethane, 1,1-bis(2,3-dicarboxyphenyl)ethane, bis(3,4-dicarboxyphenyl)methane, bis(2,3-dicarboxyphenyl)methane, bis(3,4-dicarboxyphenyl)sulfone, bis(3,4-dicarboxyphenyl)ether, 1,2,5,6-naphthalenetetracarboxylic acid, 2,3,6,7-naphthalenetetracarboxylic acid, 2,3,5,6-pyridinetetracarboxylic acid, 3,4,9,10-perylenetetracarboxylic acid, and terphenyl tetracarboxylic acid.

Among the aromatic tetracarboxylic acids of the aromatic tetracarboxylic acid residue (b-1), 3,3′,4,4′-biphenyltetracarboxylic acid and terphenyl tetracarboxylic acid are preferable from the viewpoint of low dissipation factor and film toughness.

Examples of the carboxylic acid other than the aromatic tetracarboxylic acid of the aromatic tetracarboxylic acid residue (b-1) include: aliphatic tetracarboxylic acids such as butane tetracarboxylic acid, cyclobutane tetracarboxylic acid, 1,2,3,4-cyclopentane tetracarboxylic acid, cyclohexane tetracarboxylic acid, bicyclo[2.2.1.]heptanetetracarboxylic acid, bicyclo[3.3.1.]tetracarboxylic acid, bicyclo[3.1.1.]hept-2-ene tetracarboxylic acid, bicyclo[2.2.2.]octane tetracarboxylic acid, and adamantane tetracarboxylic acid; and silicon atom-containing tetracarboxylic acids such as dimethylsilanediphthalic acid and 1,3-bis(phthalic acid)tetramethyldisiloxane.

These acids can be used as they are, or as acid anhydrides or active esters. Moreover, two or more of these acids may be used.

In the present invention, the diamine residue (a) preferably contains, to a total of 100 mol % of the diamine residue (a), the alicyclic diamine residue (a-1) at a content rate of 60 to 80 mol %. A content rate within the above-mentioned range is preferable because it is easy to achieve a low dissipation factor while maintaining the heat resistance and chemical resistance. The content rate of the alicyclic diamine residue (a-1) is more preferably 65 to 75 mol %.

Furthermore, in the present invention, the diamine residue (a) preferably contains, to a total of 100 mol % of the diamine residue (a), the aromatic diamine residue (a-2) at a content rate of 20 to 40 mol %. A content rate within the above-mentioned range is preferable from the viewpoint of heat resistance and chemical resistance. The content rate of the aromatic diamine residue (a-2) is more preferably 25 to 35 mol %.

In addition, the aromatic diamine of the aromatic diamine residue (a-2) may be partially substituted with a silicon atom-containing diamine such as 1,3-bis(3-aminopropyl)tetramethyldisiloxane and 1,3-bis(4-anilino)tetramethyldisiloxane. Use of these compounds can improve the adhesion to a substrate as well as resistance to oxygen plasma and UV ozone treatment used for cleaning or the like. The amount of the silicon atom-containing diamine is preferably 1 to 10 mol % based on all the diamine components. An amount of 1 mol % or more is preferable in terms of improving adhesion and improving resistance to plasma treatment. An amount of 10 mol % or less is preferable in terms of the toughness of the obtained resin.

Furthermore, in the present invention, the carboxylic acid residue (b) preferably contains, to a total of 100 mol % of the carboxylic acid residue (b), the aromatic tetracarboxylic acid residue (b-1) at a content rate of 60 to 100 mol %. A content rate within the above-mentioned range is preferable from the viewpoint of heat resistance and chemical resistance. The content rate of the aromatic tetracarboxylic acid residue (b-1) is more preferably 70 to 100 mol %.

In addition, the aromatic tetracarboxylic acid of the aromatic tetracarboxylic acid residue (b-1) may be partially substituted with a silicon atom-containing tetracarboxylic acid such as dimethylsilanediphthalic acid and 1,3-bis(phthalic acid)tetramethyldisiloxane. Use of these compounds can improve the adhesion to a substrate as well as resistance to oxygen plasma and UV ozone treatment used for cleaning or the like. The amount of the silicon atom-containing tetracarboxylic acid is preferably 1 to 10 mol % based on all the acid components. An amount of 1 mol % or more is preferable in terms of exhibiting an effect related to substrate adhesion and plasma treatment. An amount of 10 mol % or less is preferable in terms of mechanical properties of the obtained resin.

In the resin composition of the present invention, it is more preferable from the viewpoint of lower dielectric properties of the obtained resin that the resin (P) having an alicyclic structure and an aromatic ring structure have (a) a diamine residue and (b) a carboxylic acid residue, that the diamine residue (a) contain, to a total of 100 mol % of the diamine residue (a), (a-1) an alicyclic diamine residue at a content rate of 60 to 80 mol %, and (a-2) an aromatic diamine residue at a content rate of 20 to 40 mol %, and that the carboxylic acid residue (b) contain, to a total of 100 mol % of the carboxylic acid residue (b), (b-1) an aromatic tetracarboxylic acid residue at a content rate of 60 to 100 mol %.

In the resin composition of the present invention, it is preferable that the group having two or more alicyclic rings in the resin (P) having an alicyclic structure and an aromatic ring structure be represented by at least one group selected from the group consisting of general formulae (1) and (2):

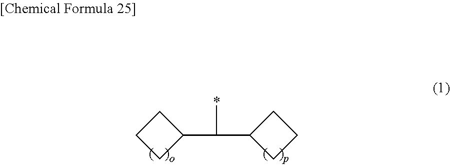

wherein o and p may be identical or different, and each represent an integer within a range of 1 to 10, and symbol * represents a bond; and

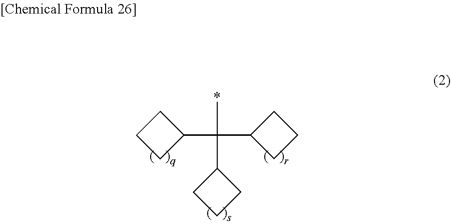

wherein q, r, and s may be identical or different, and each represent an integer within a range of 1 to 10, and symbol * represents a bond.

It is preferable that the resin (P) having an alicyclic structure and an aromatic ring structure have a group consisting of two or more alicyclic rings in either of or both of a main chain terminal and a side chain.

Preferable examples of the case where the resin (P) having an alicyclic structure and an aromatic ring structure has a group consisting of two or more alicyclic rings in a side chain include a case where a polyimide, a polybenzoxazole, or a precursor thereof has, in a side chain thereof, a group having two or more alicyclic structures. A resin having a side chain that has two or more alicyclic rings can be obtained through polymerization by a publicly known method. For example, a polyimide precursor having a side chain that has two or more alicyclic rings is obtained by reacting a tetracarboxylic dianhydride with an alcohol having two or more alicyclic structures to produce an esterified tetracarboxylic acid, and then subjecting the tetracarboxylic acid to amide polycondensation with a diamine. Introducing a bulky structure having a plurality of alicyclic rings into a side chain of a resin reduces molar polarizability per molar volume of the resin and reduces polar groups in a main chain, so that the obtained cured film tends to have a lower dissipation factor.

Examples of the case where the resin (P) having an alicyclic structure and an aromatic ring structure has a group consisting of two or more alicyclic rings in a main chain terminal include the cases described later.

In the resin composition of the present invention, it is preferable that a main chain terminal of the resin (P) having an alicyclic structure and an aromatic ring structure have at least one group selected from the group consisting of general formulae (1) and (2):

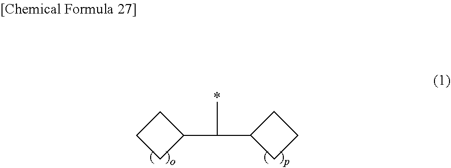

wherein o and p may be identical or different, and each represent an integer within a range of 1 to 10, and symbol * represents a bond; and

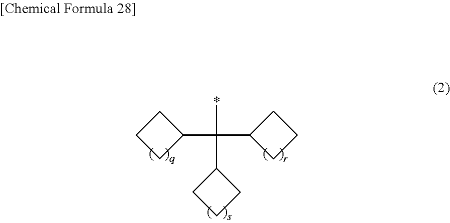

wherein q, r, and s may be identical or different, and each represent an integer within a range of 1 to 10, and symbol * represents a bond.

Preferable examples of the case where the resin (P) having an alicyclic structure and an aromatic ring structure has a group consisting of two or more alicyclic rings in a main chain terminal include a case where a main chain terminal of a polyimide, a polybenzoxazole, or a precursor thereof is reacted with a monoamine, a diamine, an acid anhydride, an alcohol, a monocarboxylic acid, or an acid chloride having two or more alicyclic structures to introduce a group consisting of two or more alicyclic rings into the main chain terminal, and two or more of these may be used. Introducing the above-mentioned bulky structure having a plurality of alicyclic rings into a main chain terminal of a resin reduces molar polarizability per molar volume of the resin and reduces polar groups at the main chain terminal, so that the obtained cured film tends to have a lower dissipation factor.

Preferable examples of the monoamine having two or more alicyclic structures include those having at least one group selected from the group consisting of the general formulae (1) and (2).

Examples of a particularly preferable structure of the monoamine having two or more alicyclic structures include structures shown below, and structures in which some hydrogen atoms, that is, 1 to 4 hydrogen atoms in these structures are substituted with an alkyl group having 1 to 20 carbon atoms, a fluoroalkyl group, an alkoxyl group, an ester group, a nitro group, a cyano group, a fluorine atom, or a chlorine atom.

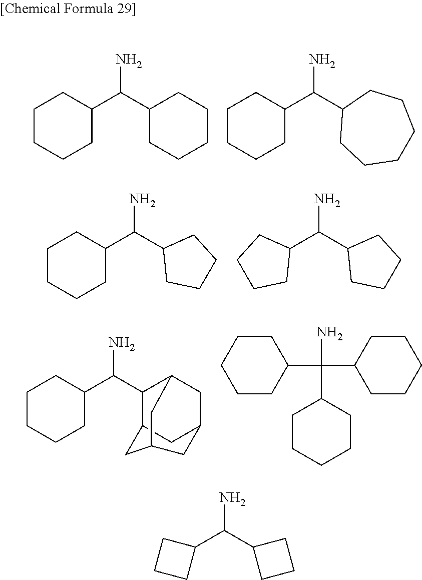

Preferable examples of the acid anhydride having two or more alicyclic structures include structures shown below.

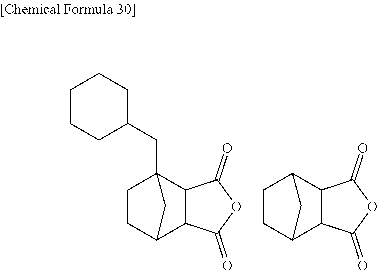

Preferable examples of the alcohol having two or more alicyclic structures include structures shown below.

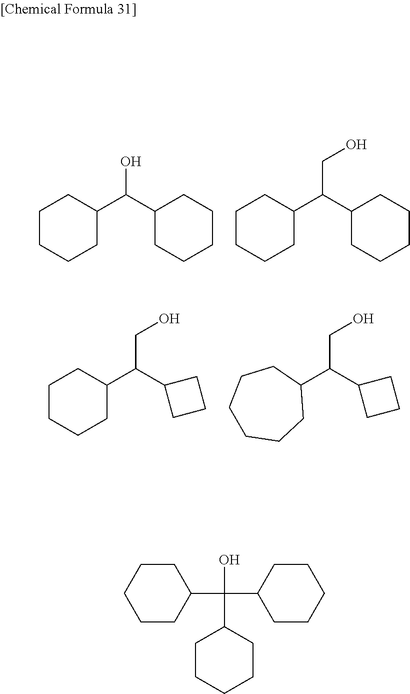

The content of the monoamine, diamine, acid anhydride, alcohol, monocarboxylic acid, acid chloride, or the like having two or more alicyclic structures is preferably within a range of 0.1 to 20 mol %, more preferably within a range of 0.5 to 10 mol % of the number of moles of the charged acid component monomer or diamine component monomer. When the content is within the above-mentioned range, a resin composition having a low dissipation factor and excellent film physical properties can be easily obtained.

The group consisting of two or more alicyclic rings introduced into the resin (P) having an alicyclic structure and an aromatic ring structure can be easily detected by the following method. For example, the group consisting of two or more alicyclic rings can be easily detected by dissolving a resin containing the group consisting of two or more alicyclic rings introduced therein in an acidic solution to decompose the resin into a diamine component and an acid component that are constituent units of the resin, and analyzing the components by gas chromatography (GC) or NMR. Alternatively, it is also possible to detect the group consisting of two or more alicyclic rings by directly analyzing the resin containing the group consisting of two or more alicyclic rings introduced therein through pyrolysis gas chromatograph (PGC), infrared spectrum, and ¹³C-NMR spectrum.

In the resin composition of the present invention, the resin (P) having an alicyclic structure and an aromatic ring structure has a group in which two or more benzene rings are bonded via a single bond. When the resin (P) having an alicyclic structure and an aromatic ring structure has such a group, a cured film obtained from the resin composition has a low dissipation factor. It is preferable that the group in which two or more benzene rings are bonded via a single bond be represented by at least one group selected from the group consisting of a formula (6) and general formulae (7), (11), and (12) from the viewpoint that the cured film tends to have a lower dissipation factor.

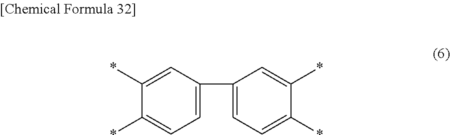

In the formula (6), symbol * represents a bond.

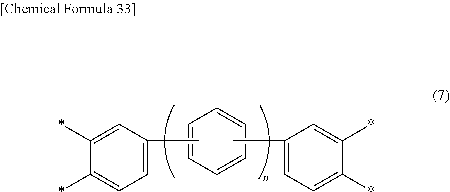

In the general formula (7), n represents an integer within a range of 1 to 10, and symbol * represents a bond.

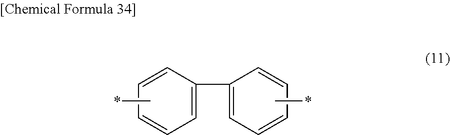

In the general formula (11), symbol * represents a bond.

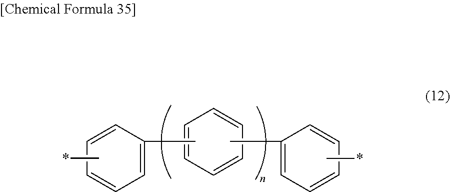

In the general formula (12), n represents an integer within a range of 1 to 10, and symbol * represents a bond.

The resin (P) having an alicyclic structure and an aromatic ring structure preferably has, in a main chain thereof, a group in which two or more benzene rings are bonded via a single bond.

A resin having, in a main chain thereof, a group in which two or more benzene rings are bonded via a single bond can be obtained through polymerization by a publicly known method. For example, a polyimide precursor having, in a main chain thereof, a group in which two or more benzene rings are bonded via a single bond can be obtained by polycondensing an aromatic tetracarboxylic dianhydride having a structure in which two or more benzene rings are bonded via a single bond with a diamine, or polycondensing a diamine having a structure in which two or more benzene rings are bonded via a single bond with an acid dianhydride.

In the resin composition of the present invention, it is preferable that the resin (P) having an alicyclic structure and an aromatic ring structure have an ester group-containing side chain, and that the resin (P) having an alicyclic structure and an aromatic ring structure contain, to a total of 100 mol % of side chains in the resin (P) having an alicyclic structure and an aromatic ring structure, the ester group-containing side chain at a rate of 60 to 95 mol %. The rate is preferably 60 mol % or more since the resistance to copper migration during thermal curing is improved. The rate is more preferably 70 mol % or more. Moreover, the rate is preferably 95 mol % or less in terms of patternability in an alkaline developer.

The rate of the ester group-containing side chain can be obtained using a nuclear magnetic resonance (NMR) apparatus by a method of detecting a peak specific to structures of the main chain and side chain of the resin. When a simple resin is analyzed, the rate of the ester group-containing side chain can be obtained by calculating the area ratio between the peak specific to the structure of the main chain and the peak specific to the ester group of the side chain in the 1H-NMR spectrum. When a resin composition or a cured film is analyzed, the resin composition or cured film is extracted with an organic solvent and concentrated, and the NMR peak area ratio is similarly calculated.

In the resin composition of the present invention, it is preferable that the resin (P) having an alicyclic structure and an aromatic ring structure have a molecular weight within a range of 100 or more and 1,000,000 or less.

Furthermore, the resin (P) having an alicyclic structure and an aromatic ring structure preferably contains, to 100 mass % in total of a component having the molecular weight within the range of 100 or more and 1,000,000 or less in the resin (P) having an alicyclic structure and an aromatic ring structure, a component having a molecular weight within a range of 5,000 or more and 1,000,000 or less at a content rate of 95 mass % or more and 100 mass % or less. A content rate of 95 mass % or more is preferable because the content of low-molecular weight components in the cured film is low, so that the heat resistance, chemical resistance, and dielectric properties tend to be improved.

The molecular weight of the resin (P) having an alicyclic structure and an aromatic ring structure can be easily calculated through measurement by gel permeation chromatography (GPC), a light scattering method, small angle X-ray scattering or the like. Herein, the “molecular weight” refers to a value calculated using the simplest GPC measurement in terms of polystyrene.

In the present invention, the molecular weight of the resin (P) having an alicyclic structure and an aromatic ring structure is measured in terms of polystyrene using a GPC (gel permeation chromatography) apparatus, a differential refractive index detector model RI-201 manufactured by Tosoh Corporation, columns including TSKgel guardcolumn α (one column), TSK α-M (one column), and TSK α-3000 (one column) manufactured by Tosoh Corporation, and developing solvents including 0.05 M lithium chloride and dimethylacetamide containing 0.1% of phosphoric acid at a flow rate of 0.7 mL/min, a column temperature of 23° C., a sample concentration of 0.1%, and an injection amount of 0.2 mL. Based on the total peak area of a molecular weight distribution chart obtained by the molecular weight measurement, the total peak area being defined as 1.00, when the peak area within a range of a molecular weight of 100 or more and 1,000,000 or less is 0.99 or more and 1.00 or less, it is determined that the resin (P) having an alicyclic structure and an aromatic ring structure has a molecular weight within a range of 100 or more and 1,000,000 or less. In addition, from the obtained molecular weight distribution chart and peak area, the molecular weight range and the content rate of the component having a molecular weight within a range of 5,000 or more and 1,000,000 or less of the resin (P) having an alicyclic structure and an aromatic ring structure are calculated.

A second aspect of the resin composition according to the present invention is a resin composition containing (P) a resin having an alicyclic structure and an aromatic ring structure, wherein the resin (P) having an alicyclic structure and an aromatic ring structure has at least one structure selected from the group consisting of general formulae (8), (9), and (10), and also has a group in which two or more benzene rings are bonded via a single bond:

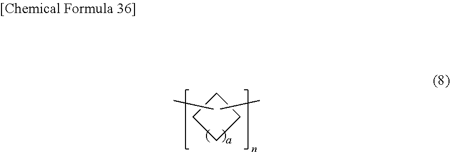

wherein a represents an integer within a range of 1 to 10, and n represents an integer within a range of 1 to 1000;

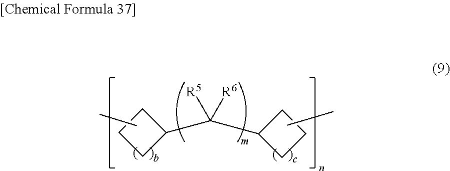

wherein R⁵ and R⁶ may be identical or different, and each represent a hydrogen atom, a methyl group, or a trifluoromethyl group, b and c may be identical or different, and each represent an integer within a range of 1 to 10, m represents an integer within a range of 1 to 10, and n represents an integer within a range of 1 to 1000; and

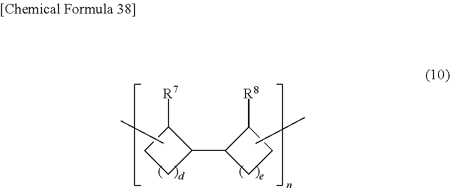

wherein R⁷ and R⁸ may be identical or different, and each represent a hydrogen atom, a methyl group, or a trifluoromethyl group, d and e may be identical or different, and each represent an integer within a range of 1 to 10, and n represents an integer within a range of 1 to 1000.

The resin composition of the present invention may contain an adhesion improver. Examples of the adhesion improver include an alkoxysilane-containing compound. The resin composition may contain two or more of them. When the resin composition contains any of these compounds, the adhesion between the cured film after firing or curing and a base material can be improved.

Specific examples of the alkoxysilane-containing compound include (N-phenylamino)ethyltrimethoxysilane, (N-phenylamino)ethyltriethoxysilane, (N-phenylamino)propyltrimethoxysilane, (N-phenylamino)propyltriethoxysilane, (N-phenylamino)butyltrimethoxysilane, (N-phenylamino)butyltriethoxysilane, vinyltrimethoxysilane, vinyltriethoxysilane, 3-glycidoxypropyltrimethoxysilane, 3-glycidoxypropyltriethoxysilane, p-styryltrimethoxysilane, 3-aminopropyltrimethoxysilane, 3-aminopropyltriethoxysilane, 3-methacryloxypropyltrimethoxysilane, 3-methacryloxypropyltriethoxysilane, 3-acryloxypropyltrimethoxysilane, 3-aminopropyltrimethoxysilane, 3-aminopropyltriethoxysilane, vinyltrichlorosilane, and vinyltris(β-methoxyethoxy)silane.

The total content of the adhesion improver is preferably 0.01 to 15 parts by mass based on 100 parts by mass of the resin (P) having an alicyclic structure and an aromatic ring structure. A total content of the adhesion improver of 0.01 parts by mass or more is preferable because the adhesion between the film after firing or curing and a base material can be improved. A total content of the adhesion improver of 15 parts by mass or less is preferable because the adhesion is improved without the alkali developability being deteriorated due to excessive adhesiveness.

The resin composition of the present invention may contain a surfactant. When the resin composition contains a surfactant, the resin composition has better wettability to the substrate.

Examples of the surfactant include fluorosurfactants such as “FLUORAD” (registered trademark) (manufactured by 3M Japan Limited), “MEGAFACE” (registered trademark) (manufactured by DIC Corporation), and “SURFLON” (registered trademark) (manufactured by Asahi Glass Company, Limited); organosiloxane surfactants such as KP341 (trade name, manufactured by Shin-Etsu Chemical Co., Ltd.), DBE (trade name, manufactured by CHISSO CORPORATION), GLANOL (trade name, manufactured by Kyoeisha Chemical Co., Ltd.), and “BYK” (registered trademark) (manufactured by BYK Japan KK); and acrylic polymer surfactants such as POLYFLOW (trade name, manufactured by Kyoeisha Chemical Co., Ltd.), and these surfactants are respectively available from the above-mentioned companies.

The resin composition of the present invention preferably contains an organic solvent.

Specific examples of the organic solvent preferably used in the present invention include: ethers such as ethylene glycol monomethyl ether, ethylene glycol monoethyl ether, propylene glycol monomethyl ether, propylene glycol monoethyl ether, ethylene glycol dimethyl ether, ethylene glycol diethyl ether, and ethylene glycol dibutyl ether; acetates such as ethylene glycol monoethyl ether acetate, propylene glycol monomethyl ether acetate, propyl acetate, butyl acetate, isobutyl acetate, 3-methoxybutyl acetate, 3-methyl-3-methoxybutyl acetate, methyl lactate, ethyl lactate, and butyl lactate; ketones such as acetylacetone, methyl propyl ketone, methyl butyl ketone, methyl isobutyl ketone, cyclopentanone, and 2-heptanone; alcohols such as butyl alcohol, isobutyl alcohol, pentanol, 4-methyl-2-pentanol, 3-methyl-2-butanol, 3-methyl-3-methoxybutanol, and diacetone alcohol; aromatic hydrocarbons such as toluene and xylene; N-methyl-2-pyrrolidone, N-cyclohexyl-2-pyrrolidone, N,N-dimethylformamide, N,N-dimethylacetamide, dimethylsulfoxide, γ-butyrolactone, 1,3-dimethyl-2-imidazolidinone, N,N-dimethylpropylene urea, 3-methoxy-N,N-dimethylpropionamide, and 5-valerolactone. These may be used alone or in combination of two or more.

Among them, organic solvents that are capable of dissolving the resin (P) having an alicyclic structure and an aromatic ring structure and that have a boiling point of 100° C. to 210° C. under atmospheric pressure are particularly preferable. When the organic solvent has a boiling point within the above-mentioned range, it is possible to avoid a case where too large an amount of the organic solvent is volatilized during the application of the composition so that the composition cannot be applied, and it is not required to increase the heat treatment temperature of the composition. Therefore, there is no restriction on the material of the base substrate. Moreover, use of an organic solvent capable of dissolving the resin (P) having an alicyclic structure and an aromatic ring structure can form a uniform coating film on a base substrate.

Specific examples of particularly preferable organic solvents having a boiling point within the above-mentioned range include cyclopentanone, ethylene glycol monomethyl ether, ethylene glycol monoethyl ether, propylene glycol monomethyl ether, methyl lactate, ethyl lactate, diacetone alcohol, 3-methyl-3-methoxybutanol, γ-butyrolactone, and N-methyl-2-pyrrolidone.

The amount of the organic solvent used in the resin composition of the present invention is preferably 100 parts by mass or more, particularly preferably 200 parts by mass or more, and is preferably 1,500 parts by mass or less, particularly preferably 1,200 parts by mass or less based on 100 parts by mass in total of the resin (P) having an alicyclic structure and an aromatic ring structure.

In the following, a method for producing the resin composition of the present invention will be described. The resin composition can be obtained, for example, by dissolving the resin (P) having an alicyclic structure and an aromatic ring structure, and optionally other components such as a photosensitizer, a crosslinking agent, an adhesiveness improver, and a crosslinking agent in an organic solvent. As a dissolution method, stirring and heating can be mentioned. In the case of heating, the heating temperature is preferably set within a range in which the performance of the resin composition is not impaired, and the heating temperature is usually from room temperature to 90° C. In addition, the order of dissolving the components is not particularly limited, and for example, there is a method of sequentially dissolving the components starting from a compound having low solubility. Further, as for components that tend to generate air bubbles at the time of dissolution by stirring, such as a surfactant and some kind of adhesiveness improver, poor dissolution of other components caused by generation of air bubbles can be prevented by first dissolving such other components and lastly adding the relevant components.

It is preferable that the resultant resin composition be filtered using a filtration filter to remove dust and particles. The filter pore size is, for example, 0.5 μm, 0.2 μm, 0.1 μm, 0.07 μm, 0.05 μm, 0.03 μm, 0.02 μm, 0.01 μm, or 0.005 μm, but it is not limited thereto. Materials of the filtration filter include polypropylene (PP), polyethylene (PE), nylon (NY), polytetrafluoroethylene (PTFE) and the like, with PE and NY being preferable.

The cured film of the present invention includes a cured product of the resin composition of the present invention, or of the resin sheet of the present invention described later.

First, a method for producing a cured film of a resin using the resin composition of the present invention will be described with reference to an example.

First, the resin composition is applied to a substrate. The substrate used may be a silicon wafer, or made from ceramics, gallium arsenide or the like, but it is not limited thereto. The substrate may be pretreated with a chemical liquid such as a silane coupling agent or a titanium chelating agent. For example, the substrate is subjected to surface treatment with a solution prepared by dissolving 0.5 to 20 mass % of the above-mentioned coupling agent in a solvent such as isopropanol, ethanol, methanol, water, tetrahydrofuran, propylene glycol monomethyl ether acetate, propylene glycol monomethyl ether, ethyl lactate, or diethyl adipate by spin coating, immersion, spray coating, steam treatment or the like. Then, the substrate can be optionally exposed to a temperature of 50° C. to 300° C. to promote the reaction between the substrate and the above-mentioned coupling agent.

Examples of the method of applying the resin composition include methods such as spin coating using a spinner, spray coating, and roll coating. The coating film thickness varies depending on the coating technique, solid content concentration and viscosity of the composition, and the like. Usually, the resin composition is applied so that the coating film obtained after the drying may have a thickness of 1 to 50 μm.

Then, the substrate to which the resin composition is applied is dried to produce a coating film. This step is also called pre-baking. The substrate is preferably dried with an oven, a hot plate, infrared rays or the like at a temperature within a range of 70 to 140° C. for 1 minute to several hours. In the case where a hot plate is used, the coating film is directly held on a plate, or held on a jig such as a proximity pin placed on a plate and heated. The material of the proximity pin may be a metal material such as aluminum and stainless steel, or a synthetic resin such as polyimide resin or “Teflon (registered trademark)”, and the proximity pin may be made from any material as long as it has heat resistance. The height of the proximity pin varies depending on the size of the substrate, the kind of the coating film, the purpose of heating and the like, and is preferably 0.1 to 10 mm.

Then, a photoresist is formed on the coating film, and the coating film is exposed to actinic rays through a mask having a desired pattern. Examples of the actinic rays used for exposure include ultraviolet rays, visible rays, electron beam, and X-ray. In the present invention, it is preferable to use i-line (365 nm), h-line (405 nm), and g-line (436 nm) of a mercury lamp. In the case where the photoresist has positive photosensitivity, the exposed part is soluble in the developer. In the case where the photoresist has negative photosensitivity, the exposed part is cured and insolubilized in the developer.

Then, the exposed coating film is baked as necessary. The temperature in the baking is preferably within a range of 50 to 180° C., more preferably within a range of 60 to 150° C. The baking time is not particularly limited, but it is preferably 10 seconds to several hours from the viewpoint of developability in the subsequent process.

After the exposure, in order to form a pattern of the resin film, the exposed part is removed using a developer in the case where the photoresist has positive photosensitivity. The developer is preferably an aqueous solution of a compound having alkalinity, such as an aqueous tetramethylammonium solution, diethanolamine, diethylaminoethanol, sodium hydroxide, potassium hydroxide, sodium carbonate, potassium carbonate, triethylamine, diethylamine, methylamine, dimethylamine, dimethylaminoethyl acetate, dimethylaminoethanol, dimethylaminoethyl methacrylate, cyclohexylamine, ethylene diamine, or hexamethylenediamine. In some cases, to the alkali aqueous solution, one or more of the following compounds may be added: polar solvents such as N-methyl-2-pyrrolidone, N,N-dimethylformamide, N,N-dimethylacetamide, dimethylsulfoxide, γ-butyrolactone, and dimethylacrylamide, alcohols such as methanol, ethanol, and isopropanol, esters such as ethyl lactate and propylene glycol monomethyl ether acetate, and ketones such as cyclopentanone, cyclohexanone, isobutyl ketone, and methyl isobutyl ketone. After the development, the resin film pattern is generally rinsed with water. For the rinsing treatment, one or more of alcohols such as ethanol and isopropyl alcohol, and esters such as ethyl lactate, propylene glycol monomethyl ether acetate, and 3-methoxymethyl propanoate may be added to the water.

After the development, the obtained pattern of the coating film is heated at a temperature within a range of 150 to 500° C. to convert the resin film into a cured relief pattern. The heat treatment is preferably performed for 5 minutes to 5 hours by selecting a temperature and raising the temperature in stages or selecting a certain temperature range and continuously raising the temperature. For example, heat treatment is performed at 130° C., 200° C., and 350° C. each for 30 minutes, or the temperature is linearly raised from room temperature to 320° C. over 2 hours.

The resin sheet of the present invention is formed from the resin composition of the present invention. In the present invention, the resin sheet is formed by applying the resin composition to a support and drying the resin composition.

An example of a method for producing a cured film of a resin using the resin sheet of the present invention will be described.

Examples of the method of applying the resin composition of the present invention to a support include methods such as spray coating, roll coating, screen printing, blade coating, die coating, calender coating, meniscus coating, bar coating, roll coating, comma roll coating, gravure coating, screen coating, and slit die coating.

Further, the coating film thickness varies depending on the coating technique, solid content concentration and viscosity of the composition, and the like. The resin sheet of the present invention preferably has a film thickness of 3 to 50 μm from the viewpoint that the lamination properties to a substrate tend to be improved. Herein, the sheet film thickness refers to the film thickness of the dried sheet.

The support is not particularly limited, and various films that are usually commercially available, such as a polyethylene terephthalate (PET) film, a polyphenylene sulfide film, and a polyimide film can be used.

The bonding surface between the support and the resin sheet may be subjected to surface treatment with silicone, a silane coupling agent, an aluminum chelating agent, polyurea or the like in order to improve adhesion and separability.

The thickness of the support is also not particularly limited, but is preferably within a range of 10 to 100 μm from the viewpoint of workability.

Moreover, the resin sheet of the present invention may have a protective film thereon in order to protect the surface thereof. The protective film makes it possible to protect the surface of the resin sheet from contaminants such as dust and dirt in the atmosphere.

Examples of the protective film include a polyolefin film and a polyester film. The protective film preferably has a low adhesive force to the resin sheet.

Then, a method for producing a cured film using a resin sheet will be described with reference to an example.

In the case of producing a cured film using a resin sheet, first, the resin sheet is bonded to a substrate. Examples of the substrate include glass substrates, silicon wafers, ceramic substrates, gallium arsenide substrates, organic circuit boards, inorganic circuit boards, and those including any of these substrates and constituent materials of a circuit disposed on the substrate, but the substrate is not limited thereto. Examples of organic circuit boards include: glass substrate copper-clad laminates such as a glass cloth-epoxy copper-clad laminate; composite copper-clad laminates such as a glass nonwoven fabric-epoxy copper-clad laminate; heat-resistant thermoplastic substrates such as a polyetherimide resin substrate, a polyetherketone resin substrate, and a polysulfone resin substrate; and flexible substrates such as a polyester copper-clad film substrate and a polyimide copper-clad film substrate. Examples of inorganic circuit boards include: ceramic substrates such as an alumina substrate, an aluminum nitride substrate, and a silicon carbide substrate; and metal substrates such as an aluminum-based substrate and an iron-based substrate. Examples of constituent materials of the circuit include: conductors containing a metal such as silver, gold, and copper; resistors containing, for example, an inorganic oxide; low-dielectric materials containing, for example, a glass material and/or a resin; high-dielectric materials containing, for example, a resin or high-dielectric constant inorganic particles; and insulators containing, for example, a glass material.

When the resin sheet has a protective film, the protective film is separated, and the resin sheet and the substrate are made to face each other and bonded together by thermocompression bonding to produce a resin film. The thermocompression bonding can be achieved by hot pressing, thermal lamination, thermal vacuum lamination or the like. The bonding temperature is preferably 40° C. or higher, more preferably 50° C. or higher, from the viewpoint of adhesion to the substrate and embeddability in the substrate. Moreover, the thermocompression bonding may be performed under reduced pressure for the purpose of removing air bubbles.

The resin film obtained from the resin sheet is subjected to exposure, baking after the exposure, development, and thermal curing as with the above-mentioned resin film obtained from the resin composition to produce a cured relief pattern.

The cured film obtained from the resin composition of the present invention can be suitably used as an interlayer insulating film or a passivation film of an electronic component or a semiconductor component.

Further, the cured film obtained from the resin composition of the present invention can be suitably used as an interlayer insulating film of an electronic component having a coil structure including two to ten repeatedly laminated layers of the cured films.

Moreover, the cured film obtained from the resin composition of the present invention can be suitably used as an insulating film of a metal wire.

Moreover, the cured film obtained from the resin composition of the present invention can be suitably used as an insulating film of an electronic component having a coil structure including a metal wire.

The electronic component or the semiconductor component of the present invention includes the cured film of the present invention arranged therein. In the electronic component or the semiconductor component of the present invention, it is preferable to arrange the cured film of the present invention as an interlayer insulating film or a passivation film in contact with a conductor, because of a low dielectric loss at the interface between the cured film and the conductor, and the efficient signal transmission due to a reduction in the transmission loss.

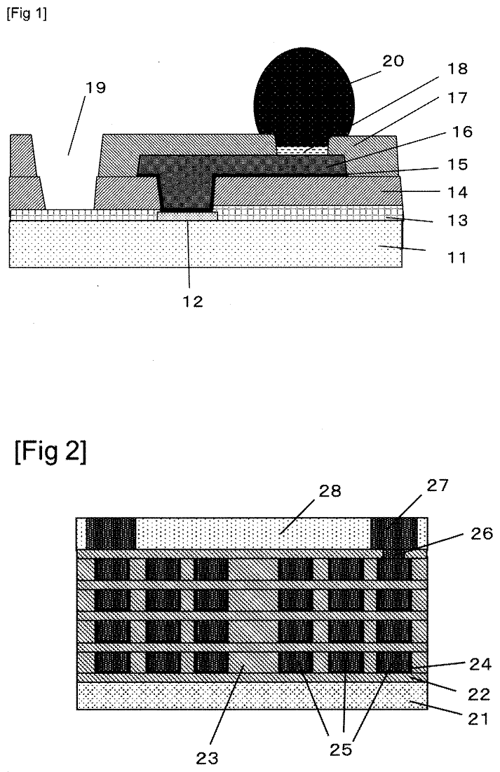

Then, an example of a method for producing an electronic component or a semiconductor component including the cured film of the present invention arranged therein will be described with reference to a drawing. FIG. 1 is an enlarged cross-sectional view of a pad portion of a semiconductor component including the cured films of the present invention arranged therein as interlayer insulating films. As shown in FIG. 1, on an Al pad 12 for input and output formed on a silicon wafer 11, a passivation film 13 is formed, and a via hole is formed in the passivation film 13. Furthermore, a cured film (interlayer insulating film 14) formed from the resin composition of the present invention is formed on the passivation film 13, and a metal (Cr, Ti or the like) film 15 is further formed on the cured film 14 so that the metal film 15 may be connected to the Al pad 12. Then, a wire (Al, Cu or the like) 16 is formed by plating. Then, a cured film (interlayer insulating film 17) of the present invention is formed on the wire (Al, Cu or the like) 16. Then, a barrier metal 18 and a solder bump 20 are formed. Then, the semiconductor component is diced along a last scribe line 19 to be cut into chips.

A first preferable aspect of the electronic component according to the present invention is an electronic component including a coil structure including two to ten repeatedly arranged layers of the cured films of the present invention as interlayer insulating films. The coil structure of the present invention is preferable in terms of a low dielectric loss at the interface between the laminated interlayer insulating films and the coil conductor, and the efficient signal transmission due to a reduction in the transmission loss.

Then, an example of a method for producing an electronic component having a coil structure including two to ten repeatedly arranged layers of the cured films of the present invention as interlayer insulating films will be described with reference to a drawing. FIG. 2 is a cross-sectional view of a coil portion of a thin film inductor including the cured films of the present invention arranged therein as interlayer insulating films. As shown in FIG. 2, on a substrate 21, an interlayer insulating film 22 is formed, and an interlayer insulating film 23 is further formed on the interlayer insulating film 22. The substrate 21 may be made from ferrite or the like. The cured film of the present invention is used as the interlayer insulating film 22 and the interlayer insulating film 23. A metal (Cr, Ti or the like) film 24 is formed in an opening in the interlayer insulating film 23, and a metal wire (Ag, Cu or the like) 25 is formed by plating on the metal film 24. The metal wire 25 (Ag, Cu or the like) is formed in a spiral form. The above-mentioned steps from forming the insulating film 22 to forming the metal wire 25 are repeated a plurality of times, and the resulting products are laminated to make the products have a function as a coil. Finally, the metal wire 25 (Ag, Cu or the like) is connected to an electrode 27 via a metal wire 26 (Ag, Cu or the like), and is sealed with a sealing resin 28. There is no upper limit to the number of insulating layers, but the number is preferably two to ten. When two or more interlayer insulating films are used, there are cases where conductors formed between the interlayer insulating films may be efficiently insulated from each other, and the electrical characteristics tend to be improved. In addition, when ten or less interlayer insulating films are used, there are cases where flatness may be ensured and processing accuracy tends to be improved.

The metal wire of the present invention includes the cured film of the present invention arranged therein. The metal wire of the present invention is preferable in terms of a low dielectric loss at the interface between the cured film and the metal wire. In an example of a method for producing the metal wire including the cured film of the present invention arranged therein, the metal wire is produced by covering the outer periphery of a metal wire made from Cu, Al, Fe, Ag, Au, or phosphor bronze with the cured film of the present invention.

A second preferable aspect of the electronic component according to the present invention is an electronic component having a coil structure including the metal wire of the present invention. The coil structure of the present invention is preferable in terms of a low dielectric loss at the interface between the cured film and the metal wire, and the efficient signal transmission due to a reduction in the transmission loss. In an example of a method for producing the electronic component having the coil structure including the metal wire of the present invention, for example, the metal wire of the present invention is wound on a ferrite core as a magnetic material to form a coil structure, and each end of the metal wire is soldered to an external electrode to form a wire-winding inductor.

### EXAMPLES

Hereinafter, the present invention will be described with reference to examples, but the present invention is not limited to these examples. The resin compositions in the examples were evaluated by the following methods.

<Production of Resin Film>

A resin composition was applied to a 6-inch silicon wafer so that the resin composition after pre-baking might have a film thickness of 16 μm. The resin composition was then pre-baked at 120° C. for 3 minutes using a hot plate (MARK-7 manufactured by Tokyo Electron Ltd.) to form a resin film.

<Method for Measuring Film Thickness>

The film thickness of a polyimide film having a refractive index of 1.63 was measured using Lambda Ace STM-602J manufactured by Dainippon Screen Mfg. Co., Ltd.

<Thermal Curing (Curing)>

A resin film was heated over 60 minutes from 50° C. to a curing temperature of 350° C. under a nitrogen stream (oxygen concentration: 20 ppm or less) using an inert oven INH-21CD (manufactured by Koyo Thermo Systems Co., Ltd.), and heat-treated at 350° C. for 60 minutes. Then, the resin film was gradually cooled until the temperature inside the oven reached 50° C. or lower to produce a cured film.

<Evaluation of Condition of Cured Film>

As for each of the resin compositions described in examples and comparative examples, a cured film produced on a silicon wafer was obtained by the above-mentioned method. The cured film was immersed in 47% hydrofluoric acid at room temperature for 3 minutes, and then washed with tap water to separate the cured film from the silicon wafer. It is preferable that the separated cured film be a glossy, smooth film. A smooth film having no wrinkles or unevenness was evaluated as “good”, and a film with wrinkles or unevenness, or a film that was brittle and was not self-supported was evaluated as “defective”.

<Evaluation of Dielectric Properties>

In order to measure the dielectric properties of a cured film, a vector network analyzer Anritsu 37225C (manufactured by ANRITSU CORPORATION) and a jig for perturbation resonator method (manufactured by KEYCOM Corporation) for measuring a frequency around 1 GHz were used. The cured film separated from the wafer by the above-mentioned method was inserted into a PTFE cylinder of the jig for perturbation resonator method and subjected to the measurement. The relative permittivity and the dissipation factor were determined from the difference in the resonance frequency and Q value between the PTFE cylinder alone without the cured film and the PTFE cylinder with the cured film inserted therein. A cured film having a relative permittivity around 1 GHz of 3.5 or less can be judged to have a low dielectric constant. The relative permittivity is more preferably 3.3 or less, still more preferably 3.0 or less. A cured film having a dissipation factor around 1 GHz of 0.0070 or less can be judged to have a low dissipation factor. The dissipation factor is more preferably 0.0050 or less, still more preferably 0.0030 or less.

<Abbreviations of Raw Materials>

The abbreviations and compound names of raw materials are shown below.
TFMB: 2,2′-bis(trifluoromethyl)benzidine
TFDC: 2,2′-bis(trifluoromethyl)-4,4′-diaminobicyclohexane
PDA: p-phenylenediamine
DAE: 4,4′-diaminodiphenyl ether
t-DACH: trans-1,4-cyclohexanediamine
DCHM: 4,4′-Diaminodicyclohexylmethane
SiDA: 1,3-bis(3-aminopropyl)tetramethyldisiloxane
BPDA: 3,3′,4,4′-biphenyltetracarboxylic dianhydride
PMDA-HS: 1,2,4,5-cyclohexanetetracarboxylic dianhydride
ODPA: 4,4′-oxydiphthalic anhydride
DMFDMA: N,N′-dimethylformamide dimethyl acetal
NMP: N-methyl-2-pyrrolidone

### <Synthesis Example 1> Synthesis of Alicyclic Monoamine

To a 0.2-L stainless steel autoclave equipped with a stirrer, 50 g of triphenylmethylamine (manufactured by Tokyo Chemical Industry Co., Ltd.), 50 g of tetrahydrofuran, and 2.5 g of a 5 mass % Ru/Al₂O₃ catalyst (manufactured by N.E. CHEMCAT CORPORATION) were added, and the autoclave was purged with nitrogen. Then, the autoclave was purged with hydrogen, and the contents were heated to 150° C. with stirring. The pressure in the vessel was raised to 7.0 MPa, and then the contents were reacted at 150° C. for 8 hours. The contents were then cooled to room temperature, the residual pressure was released, and the autoclave was purged with nitrogen. A black slurry was removed from the vessel, the catalyst was filtered off, and the filtrate was distilled under reduced pressure to remove tetrahydrofuran, whereby tricyclohexylmethylamine represented by the following formula was obtained as a desired product.

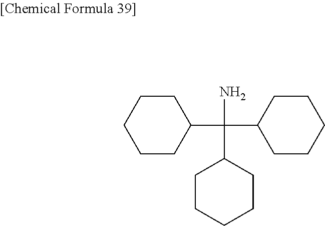 [SMILES: NC(C1CCCCC1)(C1CCCCC1)C1CCCCC1]

### <Synthesis Example 2> Synthesis of Alicyclic Diamine TFDC

To a 0.2-L stainless steel autoclave equipped with a stirrer, 20 g of TFMB (manufactured by Tokyo Chemical Industry Co., Ltd.), 100 g of hexafluoroisopropyl alcohol, and 3.0 g of a 5 mass % Ru/Al₂O₃ catalyst (manufactured by N.E. CHEMCAT CORPORATION) were added, and the autoclave was purged with nitrogen. Then, the autoclave was purged with hydrogen, and the contents were heated to 150° C. with stirring. The pressure in the vessel was raised to 7.0 MPa, and then the contents were reacted at 150° C. for 4 hours. The contents were then cooled to room temperature, the residual pressure was released, and the autoclave was purged with nitrogen. A black slurry was removed from the vessel, the catalyst was filtered off, and the filtrate was distilled under reduced pressure to remove the solvent, whereby TFDC represented by the following formula was obtained as a desired product.

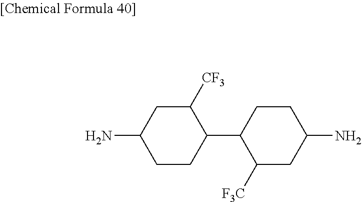 [SMILES: NC1CCC(C2CCC(N)CC2C(F)(F)F)C(C(F)(F)F)C1]

### Example 1

Under a dry nitrogen stream, 8.11 g (75 mmol) of PDA (manufactured by Daishin chemical IND. co., LTD.) and 5.01 g (25 mmol) of DAE (manufactured by Wakayama Seika Kogyo Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 60° C. for 8 hours. Then, 0.39 g (2 mmol) of dicyclohexylmethanamine (manufactured by Enamine Ltd.) was added, and the resulting mixture was further stirred for 1 hour, then cooled to room temperature, and filtered with a filtration filter having a pore size of 0.5 μm to produce a resin composition of a polyimide precursor.

### Example 2

Under a dry nitrogen stream, 8.56 g (75 mmol) of t-DACH (manufactured by Nikko Rica Corporation) and 5.01 g (25 mmol) of DAE (manufactured by Wakayama Seika Kogyo Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 80° C. for 8 hours. Then, 0.39 g (2 mmol) of dicyclohexylmethanamine (manufactured by Enamine Ltd.) was added, and the resulting mixture was further stirred for 1 hour, then cooled to room temperature, and filtered with a filtration filter having a pore size of 0.5 μm to produce a resin composition of a polyimide precursor.

### Example 3

Under a dry nitrogen stream, 15.78 g (75 mmol) of DCHM (manufactured by New Japan Chemical Co., Ltd.) and 5.01 g (25 mmol) of DAE (manufactured by Wakayama Seika Kogyo Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 60° C. for 8 hours. Then, 0.39 g (2 mmol) of dicyclohexylmethanamine (manufactured by Enamine Ltd.) was added, and the resulting mixture was further stirred for 1 hour, then cooled to room temperature, and filtered with a filtration filter having a pore size of 0.5 μm to produce a resin composition of a polyimide precursor.

### Example 4

Under a dry nitrogen stream, 24.92 g (75 mmol) of TFDC of Synthesis Example 2 and 5.01 g (25 mmol) of DAE (manufactured by Wakayama Seika Kogyo Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 80° C. for 8 hours. Then, 0.39 g (2 mmol) of dicyclohexylmethanamine (manufactured by Enamine Ltd.) was added, and the resulting mixture was further stirred for 1 hour, then cooled to room temperature, and filtered with a filtration filter having a pore size of 0.5 μm to produce a resin composition of a polyimide precursor.

### Example 5

Under a dry nitrogen stream, 8.22 g (72 mmol) of t-DACH (manufactured by Nikko Rica Corporation), 4.81 g (24 mmol) of DAE (manufactured by Wakayama Seika Kogyo Co., Ltd.), and 0.99 g (4 mmol) of SiDA (manufactured by Shin-Etsu Chemical Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 80° C. for 8 hours. Then, 0.39 g (2 mmol) of dicyclohexylmethanamine (manufactured by Enamine Ltd.) was added, and the resulting mixture was further stirred for 1 hour, then cooled to room temperature, and filtered with a filtration filter having a pore size of 0.5 μm to produce a resin composition of a polyimide precursor.

### Example 6

Under a dry nitrogen stream, 15.15 g (72 mmol) of DCHM (manufactured by New Japan Chemical Co., Ltd.), 4.81 g (24 mmol) of DAE (manufactured by Wakayama Seika Kogyo Co., Ltd.), and 0.99 g (4 mmol) of SiDA (manufactured by Shin-Etsu Chemical Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 60° C. for 8 hours. Then, 0.39 g (2 mmol) of dicyclohexylmethanamine (manufactured by Enamine Ltd.) was added, and the resulting mixture was further stirred for 1 hour, then cooled to room temperature, and filtered with a filtration filter having a pore size of 0.5 μm to produce a resin composition of a polyimide precursor.

### Example 7

Under a dry nitrogen stream, 15.15 g (72 mmol) of DCHM (manufactured by New Japan Chemical Co., Ltd.), 4.81 g (24 mmol) of DAE (manufactured by Wakayama Seika Kogyo Co., Ltd.), and 0.99 g (4 mmol) of SiDA (manufactured by Shin-Etsu Chemical Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 60° C. for 8 hours. Then, 0.39 g (2 mmol) of dicyclohexylmethanamine (manufactured by Enamine Ltd.) was added, and the resulting mixture was further stirred for 1 hour, and then cooled to 40° C. To the mixture, a solution of 23.83 g (200 mmol) of DMFDMA (manufactured by Mitsubishi Rayon Co., Ltd.) diluted with 20 g of NMP was added dropwise over 10 minutes. After completion of the dropwise addition, stirring was continued at 40° C. for 2 hours. Then, a solution of 30.0 g (500 mmol) of acetic acid diluted with 25 g of NMP was added dropwise, and the resulting mixture was stirred for 1 hour. After completion of the stirring, the solution was poured into 3 L of water, and a precipitate of polymer solids was collected by filtration. Further, the polymer solids were washed three times with 3 L of water, and the collected polymer solids were dried in a vacuum dryer at 50° C. for 72 hours to produce a polyimide precursor. The polyimide precursor had an esterification rate of 77%. In 25 g of NMP, 5 g of the polyimide precursor was dissolved, and the resulting solution was filtered with a filtration filter having a pore size of 0.5 μm to produce a resin composition of a polyimide precursor.

### Example 8

Under a dry nitrogen stream, 7.42 g (65 mmol) of t-DACH (manufactured by Nikko Rica Corporation) and 7.01 g (35 mmol) of DAE (manufactured by Wakayama Seika Kogyo Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 80° C. for 8 hours. Then, 0.39 g (2 mmol) of dicyclohexylmethanamine (manufactured by Enamine Ltd.) was added, and the resulting mixture was further stirred for 1 hour, then cooled to room temperature, and filtered with a filtration filter having a pore size of 0.5 μm to produce a resin composition of a polyimide precursor.

### Example 9

Under a dry nitrogen stream, 8.56 g (75 mmol) of t-DACH (manufactured by Nikko Rica Corporation) and 5.01 g (25 mmol) of DAE (manufactured by Wakayama Seika Kogyo Co., Ltd.) were dissolved in 200 g of NMP heated to 40° C. To the resulting solution, 23.83 g (81 mmol) of BPDA (manufactured by Mitsubishi Chemical Corporation) and 4.48 g (20 mmol) of PMDA-HS (manufactured by IWATANI INDUSTRIAL GASES CORPORATION) were added, and the resulting mixture was stirred at 80° C. for 8 hours. Then, 0.39 g (2 mmol) of dicyclohexylmethanamine (manufactured by Enamine Ltd.) was added, and the resulting mixture was further stirred for 1 hour, then cooled to room temperature, and filtered with a filtration filter having a pore size of 0.5 μm to produce a resin composition of a polyimide precursor.

### Example 10

Under a dry nitrogen stream, 8.11 g (75 mmol) of PDA (manufactured by Daishin chemical IND. co., LTD.) and 5.01 g (25 mmol) of DAE (manufactured by Wakayama Seika Kogyo Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 60° C. for 8 hours. Then, 0.55 g (2 mmol) of tricyclohexylmethylamine of Synthesis Example 1 was added, and the resulting mixture was further stirred for 1 hour, then cooled to room temperature, and filtered with a filtration filter having a pore size of 0.5 μm to produce a resin composition of a polyimide precursor.

### Example 11

Under a dry nitrogen stream, 8.56 g (75 mmol) of t-DACH (manufactured by Nikko Rica Corporation) and 5.01 g (25 mmol) of DAE (manufactured by Wakayama Seika Kogyo Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 80° C. for 8 hours. Then, 0.55 g (2 mmol) of tricyclohexylmethylamine of Synthesis Example 1 was added, and the resulting mixture was further stirred for 1 hour, then cooled to room temperature, and filtered with a filtration filter having a pore size of 0.5 μm to produce a resin composition of a polyimide precursor.

### Example 12

Under a dry nitrogen stream, 15.78 g (75 mmol) of DCHM (manufactured by New Japan Chemical Co., Ltd.) and 5.01 g (25 mmol) of DAE (manufactured by Wakayama Seika Kogyo Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 60° C. for 8 hours. Then, 0.55 g (2 mmol) of tricyclohexylmethylamine of Synthesis Example 1 was added, and the resulting mixture was further stirred for 1 hour, then cooled to room temperature, and filtered with a filtration filter having a pore size of 0.5 μm to produce a resin composition of a polyimide precursor.

### Example 13

Under a dry nitrogen stream, 8.22 g (72 mmol) of t-DACH (manufactured by Nikko Rica Corporation), 4.81 g (24 mmol) of DAE (manufactured by Wakayama Seika Kogyo Co., Ltd.), and 0.99 g (4 mmol) of SiDA (manufactured by Shin-Etsu Chemical Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 80° C. for 8 hours. Then, 0.55 g (2 mmol) of tricyclohexylmethylamine of Synthesis Example 1 was added, and the resulting mixture was further stirred for 1 hour, then cooled to room temperature, and filtered with a filtration filter having a pore size of 0.5 μm to produce a resin composition of a polyimide precursor.

### Example 14

Under a dry nitrogen stream, 15.15 g (72 mmol) of DCHM (manufactured by New Japan Chemical Co., Ltd.), 4.81 g (24 mmol) of DAE (manufactured by Wakayama Seika Kogyo Co., Ltd.), and 0.99 g (4 mmol) of SiDA (manufactured by Shin-Etsu Chemical Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 60° C. for 8 hours. Then, 0.55 g (2 mmol) of tricyclohexylmethylamine of Synthesis Example 1 was added, and the resulting mixture was further stirred for 1 hour, then cooled to room temperature, and filtered with a filtration filter having a pore size of 0.5 μm to produce a resin composition of a polyimide precursor.

### Example 15

Under a dry nitrogen stream, 8.11 g (75 mmol) of PDA (manufactured by Daishin chemical IND. co., LTD.) and 5.01 g (25 mmol) of DAE (manufactured by Wakayama Seika Kogyo Co., Ltd.) were dissolved in 200 g of NMP heated to 40° C. To the resulting solution, 30.89 g (105 mmol) of BPDA (manufactured by Mitsubishi Chemical Corporation) was added, and the resulting mixture was stirred at 60° C. for 8 hours. Then, 1.95 g (10 mmol) of dicyclohexylmethanamine (manufactured by Enamine Ltd.) was added, and the resulting mixture was further stirred for 1 hour, then cooled to room temperature, and filtered with a filtration filter having a pore size of 0.5 μm to produce a resin composition of a polyimide precursor.

### Example 16

Under a dry nitrogen stream, 15.15 g (72 mmol) of DCHM (manufactured by New Japan Chemical Co., Ltd.), 4.81 g (24 mmol) of DAE (manufactured by Wakayama Seika Kogyo Co., Ltd.), and 0.99 g (4 mmol) of SiDA (manufactured by Shin-Etsu Chemical Co., Ltd.) were dissolved in 200 g of NMP heated to 40° C. To the resulting solution, 29.72 g (101 mmol) of BPDA (manufactured by Mitsubishi Chemical Corporation) was added, and the resulting mixture was stirred at 60° C. for 8 hours. Then, 0.42 g (2 mmol) of DCHM (manufactured by New Japan Chemical Co., Ltd.) was added, and the resulting mixture was further stirred for 1 hour, then cooled to room temperature, and filtered with a filtration filter having a pore size of 0.5 μm to produce a resin composition of a polyimide precursor.

### Comparative Example 1

Under a dry nitrogen stream, 8.11 g (75 mmol) of PDA (manufactured by Daishin chemical IND. co., LTD.) and 5.01 g (25 mmol) of DAE (manufactured by Wakayama Seika Kogyo Co., Ltd.) were dissolved in 200 g of NMP heated to 40° C. To the resulting solution, 29.42 g (100 mmol) of BPDA (manufactured by Mitsubishi Chemical Corporation) was added, and the resulting mixture was stirred at 60° C. for 8 hours. Then, the resulting solution was cooled to room temperature, and filtered with a filtration filter having a pore size of 0.5 μm to produce a resin composition of a polyimide precursor.

### Comparative Example 2

Under a dry nitrogen stream, 8.56 g (75 mmol) of t-DACH (manufactured by Nikko Rica Corporation) and 5.01 g (25 mmol) of DAE (manufactured by Wakayama Seika Kogyo Co., Ltd.) were dissolved in 200 g of NMP heated to 40° C. To the resulting solution, 31.02 g (100 mmol) of OPDA (manufactured by Shanghai Research Institute of Synthetic Resins) was added, and the resulting mixture was stirred at 80° C. for 8 hours. Then, the resulting solution was cooled to room temperature, and filtered with a filtration filter having a pore size of 0.5 μm to produce a resin composition of a polyimide precursor.

### Comparative Example 3

Under a dry nitrogen stream, 11.42 g (100 mmol) of t-DACH (manufactured by Nikko Rica Corporation) was dissolved in 200 g of NMP heated to 40° C. To the resulting solution, 22.42 g (100 mmol) of PMDA-HS (manufactured by IWATANI INDUSTRIAL GASES CORPORATION) was added, and the resulting mixture was stirred at 80° C. for 8 hours. Then, the resulting solution was cooled to room temperature, and filtered with a filtration filter having a pore size of 0.5 μm to produce a resin composition of a polyimide precursor.

### Comparative Example 4

Under a dry nitrogen stream, 8.11 g (75 mmol) of PDA (manufactured by Daishin chemical IND. co., LTD.) and 5.01 g (25 mmol) of DAE (manufactured by Wakayama Seika Kogyo Co., Ltd.) were dissolved in 200 g of NMP heated to 40° C. To the resulting solution, 22.42 g (100 mmol) of PMDA-HS (manufactured by IWATANI INDUSTRIAL GASES CORPORATION) was added, and the resulting mixture was stirred at 60° C. for 8 hours. Then, the resulting solution was cooled to room temperature, and filtered with a filtration filter having a pore size of 0.5 μm to produce a resin composition of a polyimide precursor.

The compositions and evaluation results of the above-mentioned examples are shown in Tables 1 and 2 for Examples 1 to 16 and Comparative Examples 1 to 4.

TABLE 1-1

| | Diamine residue | | | | | | Carboxylic acid residue | | | |
|---|---|---|---|---|---|---|---|---|---|---|
| | (a-1) | | (a-2) | | | | (b-1) | | Other | |
| | Alicyclic | | Aromatic | | Other | | Aromatic | | carboxylic | |
| | diamine | | diamine | | diamine | | tetracarboxylic acid | | acid | |
| No. | component | | component | | components | | component | | components | |
| Example 1 | — | | DAE | | PDA | | BPDA | | — | |
| | | | 25 | mmol | 75 | mmol | 101 | mmol | | |
| | | | 5.01 | g | 8.11 | g | 29.72 | g | | |
| Example 2 | t-DACH | | DAE | | — | | BPDA | | — | |
| | 75 | mmol | 25 | mmol | | | 101 | mmol | | |
| | 8.56 | g | 5.01 | g | | | 29.72 | g | | |
| Example 3 | DCHM | | DAE | | — | | BPDA | | — | |
| | 75 | mmol | 25 | mmol | | | 101 | mmol | | |
| | 15.78 | g | 5.01 | g | | | 29.72 | g | | |
| Example 4 | TFDC | | DAE | | — | | BPDA | | — | |
| | 75 | mmol | 25 | mmol | | | 101 | mmol | | |
| | 24.92 | g | 5.01 | g | | | 29.72 | g | | |
| Example 5 | t-DACH | | DAE | | SiDA | | BPDA | | — | |
| | 72 | mmol | 24 | mmol | 4 | mmol | 101 | mmol | | |
| | 8.22 | g | 4.81 | g | 0.99 | g | 29.72 | g | | |
| Example 6 | DCHM | | DAE | | SiDA | | BPDA | | — | |
| | 72 | mmol | 24 | mmol | 4 | mmol | 101 | mmol | | |
| | 15.15 | g | 4.81 | g | 0.99 | g | 29.72 | g | | |
| Example 7 | DCHM | | DAE | | SiDA | | BPDA | | — | |
| | 72 | mmol | 24 | mmol | 4 | mmol | 101 | mmol | | |
| | 15.15 | g | 4.81 | g | 0.99 | g | 29.72 | g | | |
| Example 8 | t-DACH | | DAE | | — | | BPDA | | — | |
| | 65 | mmol | 35 | mmol | | | 101 | mmol | | |
| | 7.42 | g | 7.01 | g | | | 29.72 | g | | |
| Example 9 | t-DACH | | DAE | | — | | BPDA | | PMDA-HS | |
| | 75 | mmol | 25 | mmol | | | 81 | mmol | 20 | mmol |
| | 8.56 | g | 5.01 | g | | | 23.83 | g | 4.48 | g |

| | | | | | |
|---|---|---|---|---|---|
| Example 10 | — | DAE | PDA | BPDA | — |

| | | | | | |
|---|---|---|---|---|---|
| 25 | mmol | 75 | mmol | 101 | mmol |
| 5.01 | g | 8.11 | g | 29.72 | g |

TABLE 1-2

| | | | | | | Dielectric properties | |
|---|---|---|---|---|---|---|---|
| | | | | | | Relative | Dissipation |
| | | | Other | | Condition of | permittivity | factor |
| No. | Component of main chain terminal | | components | | cured film | (1 GHz) | (1 GHz) |
| Example 1 | Dicyclohexylmethanamine | | — | | Good | 3.27 | 0.0037 |
| | 2 | mmol | | | | | |
| | 0.39 | g | | | | | |
| Example 2 | Dicyclohexylmethanamine | | — | | Good | 3.09 | 0.0024 |
| | 2 | mmol | | | | | |
| | 0.39 | g | | | | | |
| Example 3 | Dicyclohexylmethanamine | | — | | Good | 2.83 | 0.0026 |
| | 2 | mmol | | | | | |
| | 0.39 | g | | | | | |
| Example 4 | Dicyclohexylmethanamine | | — | | Good | 2.96 | 0.0025 |
| | 2 | mmol | | | | | |
| | 0.39 | g | | | | | |
| Example 5 | Dicyclohexylmethanamine | | | | Good | 3.19 | 0.0025 |
| | 2 | mmol | | | | | |
| | 0.39 | g | | | | | |
| Example 6 | Dicyclohexylmethanamine | | — | | Good | 2.84 | 0.0028 |
| | 2 | mmol | | | | | |
| | 0.39 | g | | | | | |
| Example 7 | Dicyclohexylmethanamine | | DMFDMA | | Good | 3.23 | 0.0035 |
| | 2 | mmol | 23.83 | g | | | |
| | 0.39 | g | 200 | mmol | | | |
| Example 8 | Dicyclohexylmethanamine | | — | | Good | 3.22 | 0.0029 |
| | 2 | mmol | | | | | |
| | 0.39 | g | | | | | |
| Example 9 | Dicyclohexylmethanamine | | — | | Good | 3.17 | 0.0042 |
| | 2 | mmol | | | | | |
| | 0.39 | g | | | | | |
| Example 10 | Tricyclohexylmethylamine | | — | | Good | 3.22 | 0.0034 |
| | 2 | mmol | | | | | |
| | 0.55 | g | | | | | |

TABLE 2-1

| | Diamine residue | | | | | | Carboxylic acid residue | | | |
|---|---|---|---|---|---|---|---|---|---|---|
| | (a-1) | | (a-2) | | | | (b-1) | | Other | |
| | Alicyclic | | Aromatic | | Other | | Aromatic | | carboxylic | |
| | diamine | | diamine | | diamine | | tetracarboxylic acid | | acid | |
| No. | component | | component | | components | | component | | components | |
| Example 11 | t-DACH | | DAE | | — | | BPDA | | — | |
| | 75 | mmol | 25 | mmol | | | 101 | mmol | | |
| | 8.56 | g | 5.01 | g | | | 29.72 | g | | |
| Example 12 | DCHM | | DAE | | — | | BPDA | | — | |
| | 75 | mmol | 25 | mmol | | | 101 | mmol | | |
| | 15.78 | g | 5.01 | g | | | 29.72 | g | | |
| Example 13 | t-DACH | | DAE | | SiDA | | BPDA | | — | |
| | 72 | mmol | 24 | mmol | 4 | mmol | 101 | mmol | | |
| | 8.22 | g | 4.81 | g | 0.99 | g | 29.72 | g | | |
| Example 14 | DCHM | | DAE | | SiDA | | BPDA | | — | |
| | 72 | mmol | 24 | mmol | 4 | mmol | 101 | mmol | | |
| | 15.15 | g | 4.81 | g | 0.99 | g | 29.72 | g | | |
| Example 15 | — | | DAE | | PDA | | BPDA | | — | |
| | | | 25 | mmol | 75 | mmol | 105 | mmol | | |
| | | | 5.01 | g | 8.11 | g | 30.89 | g | | |
| Example 16 | DCHM | | DAE | | SiDA | | BPDA | | — | |
| | 72 | mmol | 24 | mmol | 4 | mmol | 101 | mmol | | |
| | 15.15 | g | 4.81 | g | 0.99 | g | 29.72 | g | | |
| Comparative | — | | DAE | | PDA | | BPDA | | — | |
| Example 1 | | | 25 | mmol | 75 | mmol | 100 | mmol | | |
| | | | 5.01 | g | 8.11 | g | 29.42 | g | | |
| Comparative | t-DACH | | DAE | | — | | BDPA | | — | |
| Example 2 | 75 | mmol | 25 | mmol | | | 100 | mmol | | |
| | 8.56 | g | 5.01 | g | | | 31.02 | g | | |
| Comparative | t-DACH | | — | | — | | — | | PMDA-HS | |
| Example 3 | 100 | mmol | | | | | | | 100 | mmol |
| | 11.42 | g | | | | | | | 22.42 | g |
| Comparative | — | | DAE | | PDA | | — | | PMDA-HS | |
| Example 4 | | | 25 | mmol | 75 | mmol | | | 100 | mmol |
| | | | 5.01 | g | 8.11 | g | | | 22.42 | g |

TABLE 2-2

| | | | | | Dielectric properties | |
|---|---|---|---|---|---|---|
| | | | Other | Condition of | Relative | Dissipation |
| No. | Component of main chain terminal | | components | cured film | permittivity | factor |
| Example 11 | Tricyclohexylmethylamine | | — | Good | 3.04 | 0.0024 |
| | 2 | mmol | | | | |
| | 0.55 | g | | | | |
| Example 12 | Tricyclohexylmethylamine | | — | Good | 2.82 | 0.0025 |
| | 2 | mmol | | | | |
| | 0.55 | g | | | | |
| Example 13 | Tricyclohexylmethylamine | | — | Good | 3.16 | 0.0025 |
| | 2 | mmol | | | | |
| | 0.55 | g | | | | |
| Example 14 | Tricyclohexylmethylamine | | — | Good | 2.94 | 0.0026 |
| | 2 | mmol | | | | |
| | 0.55 | g | | | | |
| Example 15 | Dicyclohexylmethanamine | | — | Good | 3.17 | 0.0032 |
| | 10 | mmol | | | | |
| | 1.95 | g | | | | |
| Example 16 | DCHM | | — | Good | 3.04 | 0.0056 |
| | 2 | mmol | | | | |
| | 0.42 | g | | | | |

| | | | | | |
|---|---|---|---|---|---|
| Comparative | — | — | Good | 3.27 | 0.0078 |
| Example 1 | | | | | |
| Comparative | — | — | Good | 3.52 | 0.0106 |
| Example 2 | | | | | |
| Comparative | — | — | Defective | Measurement | Measurement |
| Example 3 | | | | impossible | impossible |
| Comparative | — | — | Defective | Measurement | Measurement |
| Example 4 | | | | impossible | impossible |

### INDUSTRIAL APPLICABILITY

The resin composition of the present invention is suitably used in applications such as passivation films and insulating films for rewiring of semiconductor devices, interlayer insulating films of thin film inductors, insulating films of wire-winding inductors, insulating films of organic electroluminescence (hereinafter referred to as EL) elements, planarizing films of thin film transistor (hereinafter referred to as TFT) substrates for driving display devices including organic EL elements, wiring protective insulating films of circuit boards, on-chip micro lenses of solid-state imaging devices, and planarizing films for various displays and solid-state imaging devices.

### DESCRIPTION OF REFERENCE SIGNS

11: Silicon wafer
12: Al pad
13: Passivation film
14: Interlayer insulating film
15: Metal (Cr, Ti or the like) film
16: Wire (Al, Cu or the like)
17: Interlayer insulating film
18: Barrier metal
19: Scribe line
20: Solder bump
21: Substrate
22: Interlayer insulating film
23: Interlayer insulating film
24: Metal (Cr, Ti or the like) film
25: Metal wire (Ag, Cu or the like)
26: Metal wire (Ag, Cu or the like)
27: Electrode
28: Sealing resin

1. A resin composition comprising (P) a resin having an alicyclic structure and an aromatic ring structure,
wherein the resin (P) having an alicyclic structure and an aromatic ring structure has a group having two or more alicyclic rings, and also has a group in which two or more benzene rings are bonded via a single bond.

2. The resin composition according to claim 1, wherein the group having two or more alicyclic rings in the resin (P) having an alicyclic structure and an aromatic ring structure is represented by at least one group selected from the group consisting of general formulae (1) and (2): 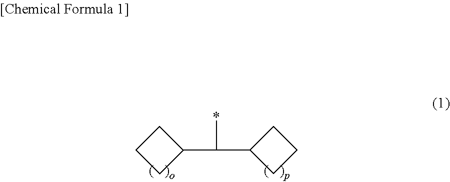
wherein o and p may be identical or different, and each represent an integer within a range of 1 to 10, and symbol * represents a bond; and 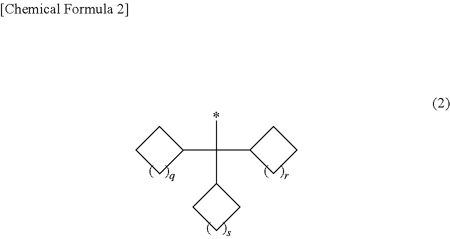
wherein q, r, and s may be identical or different, and each represent an integer within a range of 1 to 10, and symbol * represents a bond.

3. The resin composition according to claim 1, wherein a main chain terminal of the resin (P) having an alicyclic structure and an aromatic ring structure has at least one group selected from the group consisting of general formulae (1) and (2): 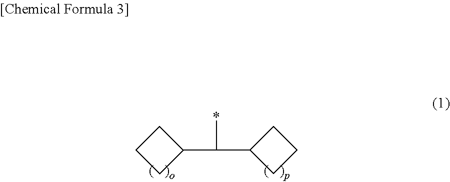
wherein o and p may be identical or different, and each represent an integer within a range of 1 to 10, and symbol * represents a bond; and 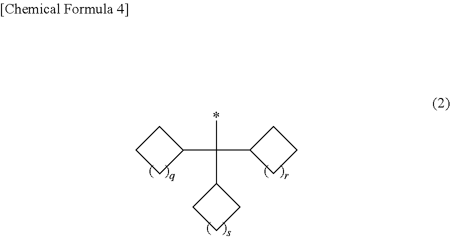
wherein q, r, and s may be identical or different, and each represent an integer within a range of 1 to 10, and symbol * represents a bond.

4. The resin composition according to claim 1, wherein the resin (P) having an alicyclic structure and an aromatic ring structure contains at least one resin selected from the group consisting of a polyamide, a polyimide, a polyamic acid, a polyamic acid ester, a polybenzoxazole, and a polyhydroxyamide.

5. The resin composition according to claim 1, wherein the resin (P) having an alicyclic structure and an aromatic ring structure has (a) a diamine residue and (b) a carboxylic acid residue,
the diamine residue (a) contains, to a total of 100 mol % of the diamine residue (a), (a-1) an alicyclic diamine residue at a content rate of 60 to 80 mol %, and (a-2) an aromatic diamine residue at a content rate of 20 to 40 mol %, and
the carboxylic acid residue (b) contains, to a total of 100 mol % of the carboxylic acid residue (b), (b-1) an aromatic tetracarboxylic acid residue at a content rate of 60 to 100 mol %.

6. The resin composition according to claim 5, wherein the alicyclic diamine residue (a-1) has at least one structure selected from the group consisting of general formulae (3), (4), and (5): 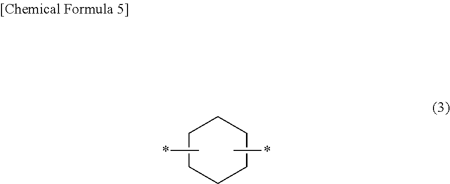
wherein symbol * represents a bond; 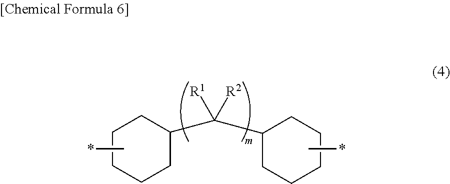
wherein R¹ and R² may be identical or different, and each represent a hydrogen atom, a methyl group, or a trifluoromethyl group, m represents an integer within a range of 1 to 10, and symbol * represents a bond; and 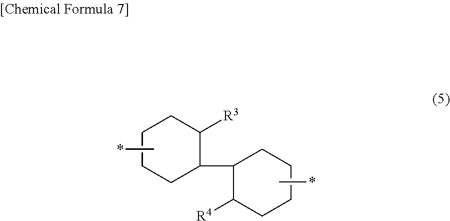
wherein R³ and R⁴ may be identical or different, and each represent a hydrogen atom, a methyl group, or a trifluoromethyl group, and symbol * represents a bond.

7. The resin composition according to claim 5, wherein the aromatic tetracarboxylic acid residue (b-1) has at least one structure selected from the group consisting of a formula (6) and a general formula (7): 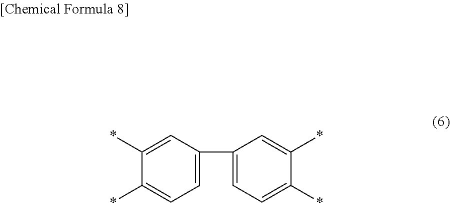
wherein symbol * represents a bond; and 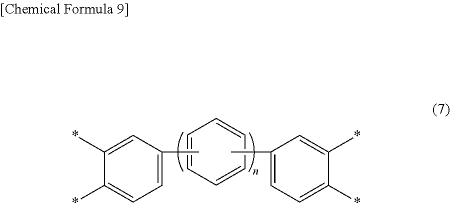
wherein n represents an integer within a range of 1 to 10, and symbol * represents a bond.

8. The resin composition according to claim 1, wherein the resin (P) having an alicyclic structure and an aromatic ring structure has an ester group-containing side chain, and
the resin (P) having an alicyclic structure and an aromatic ring structure contains, to a total of 100 mol % of side chains in the resin (P) having an alicyclic structure and an aromatic ring structure, the ester group-containing side chain at a rate of 60 to 95 mol %.

9. The resin composition according to claim 1, wherein the resin (P) having an alicyclic structure and an aromatic ring structure has a molecular weight within a range of 100 or more and 1,000,000 or less.

10. The resin composition according to claim 9, wherein the resin (P) having an alicyclic structure and an aromatic ring structure contains, to 100 mass % in total of a component having the molecular weight within the range of 100 or more and 1,000,000 or less in the resin (P) having an alicyclic structure and an aromatic ring structure, a component having a molecular weight within a range of 5,000 or more and 1,000,000 or less at a content rate of 95 mass % or more and 100 mass % or less.

11. A resin composition comprising (P) a resin having an alicyclic structure and an aromatic ring structure,
wherein the resin (P) having an alicyclic structure and an aromatic ring structure has at least one structure selected from the group consisting of general formulae (8), (9), and (10), and also has a group in which two or more benzene rings are bonded via a single bond: 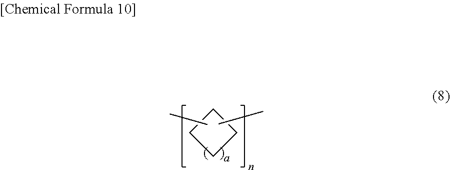
wherein a represents an integer within a range of 1 to 10, and n represents an integer within a range of 1 to 1000; 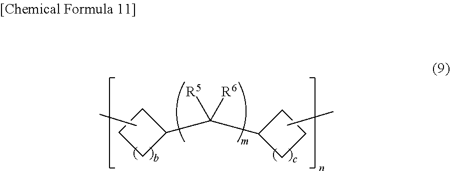
wherein R⁵ and R⁶ may be identical or different, and each represent a hydrogen atom, a methyl group, or a trifluoromethyl group, b and c may be identical or different, and each represent an integer within a range of 1 to 10, m represents an integer within a range of 1 to 10, and n represents an integer within a range of 1 to 1000; and 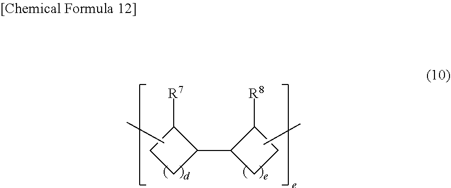
wherein R⁷ and R⁸ may be identical or different, and each represent a hydrogen atom, a methyl group, or a trifluoromethyl group, d and e may be identical or different, and each represent an integer within a range of 1 to 10, and n represents an integer within a range of 1 to 1000.

12. A resin sheet comprising the resin composition according to claim 1.

13. The resin sheet according to claim 12, having a film thickness of 3 to 50 μm.

14. A cured film comprising a cured product of the resin composition according to claim 1.

15. An electronic component or a semiconductor component comprising the cured film according to claim 14 arranged therein.

16. An electronic component comprising a coil structure including two to ten repeatedly arranged layers of the cured films according to claim 14 as interlayer insulating films.

17. A metal wire comprising the cured film according to claim 14 arranged therein.

18. An electronic component comprising a coil structure including the metal wire according to claim 17.
